(19) United States
(12) Patent Application Publication
(10) Pub. No.: US 2014/0210140 A1
(43) Pub. Date: Jul. 31, 2014

(54) NANOIMPRINTING METHOD AND RESIST COMPOSITION EMPLOYED IN THE NANOIMPRINTING METHOD

(71) Applicant: FUJIFILM CORPORATION, Tokyo (JP)

(72) Inventors: Tadashi OMATSU, Haibara-gun (JP); Kazuharu Nakamura, Haibara-gun (JP); Satoshi Wakamatsu, Haibara-gun (JP)

(73) Assignee: FUJIFILM CORPORATION, Tokyo (JP)

(21) Appl. No.: 14/229,410

(22) Filed: Mar. 28, 2014

Related U.S. Application Data
(63) Continuation of application No. PCT/JP2012/075872, filed on Sep. 28, 2012.

(30) Foreign Application Priority Data
Sep. 30, 2011 (JP) 2011-217552

(51) Int. Cl. C09D 133/22; B29C 59/02; C09D 133/08

(52) U.S. Cl. CPC C09D 133/22; C09D 133/08; B29C 59/026
USPC 264/447; 522/33; 522/39; 522/63

(57) ABSTRACT

A nanoimprinting method employs a resist composition including polymerizable compounds and a polymerization initiating agent, each having absorption spectrum properties with absorption regions within a range from 250 nm to 500 nm. The polymerization initiating agent has an absorption region with a longer wavelength end wavelength longer than the longer wavelength end wavelength of the absorption region of the polymerizable compounds. Further, exposure of the resist composition is executed by light having spectral intensity properties that satisfy a predetermined relational formula. The present invention enables contamination of molds by adhered matter to be suppressed, and enables formation of resist patterns having sufficient etching resistance by nanoimprinting.

### TECHNICAL FIELD

The present invention is related to a nanoimprinting method that employs a mold having a predetermined pattern of protrusions and recesses on a surface thereof, and to a resist composition which is employed in the nanoimprinting method.

### BACKGROUND ART

A nanoimprinting method that employs an ultraviolet light curable resist composition has been proposed in detail by Willson, et al., for example.

For example, PCT Japanese Publication No. 2007-523249 discloses a resin for optical nanoimprinting that exhibits high etching resistance as a representative example of an ultraviolet light curable resist composition for use as a dry etching resist. In addition, Japanese Unexamined Patent Publication No. 2007-186570 discloses defining Ohnishi parameters and ring parameters in order to improve the dry etching resistance of ultraviolet light curable resist compositions.

The inventions of PCT Japanese Publication No. 2007-523249 and Japanese Unexamined Patent Publication No. 2007-186570 both utilize ultraviolet light curable polymerization initiating agents having absorption regions in the vicinity of 300 nm, and cure the resist compositions by irradiation of ultraviolet rays.

### DISCLOSURE OF THE INVENTION

However, the method disclosed in PCT Japanese Publication No. 2007-523249 exhibits insufficient etching resistance with respect to dry etching, and there is a problem that favorable processing precision cannot be obtained in a subsequent substrate process that employs the resist following nanoimprinting as a mask. Meanwhile, in the case that a polymerizable compound having aromatic groups is utilized as a constituent material of the resist composition in order to improve dry etching resistance as in the method of Japanese Unexamined Patent Publication No. 2007-186570, organic matter becomes adhered to the surface of a pattern of protrusions and recesses of a mold each time that imprinting operations are repeated, resulting in the surface becoming easily contaminated. Contamination of the patterned surface of the mold will be a factor that deteriorates the release properties of the mold and the pattern forming properties of resist patterns.

As described above, conventional nanoimprinting methods cannot suppress contamination of molds by adhered matter nor form resist patterns having sufficient etching resistance.

The present invention has been developed in view of the foregoing circumstances. It is an object of the present invention to provide a nanoimprinting method that suppresses contamination of molds by adhered matter and enables resist patterns having sufficient etching resistance to be formed. It is another object of the present invention to provide a resist composition to be employed in the nanoimprinting method.

A nanoimprinting method of the present invention that achieves the above objective comprises the steps of:

employing a mold having a fine pattern of protrusions and recesses on a surface thereof;

exposing a resist composition coated on a substrate to be processed while the resist composition is pressed with the pattern of protrusions and recesses, to cure the resist composition; and

separating the mold from the resist composition; characterized by:

the resist composition including polymerizable compounds and a polymerization initiating agent, each having absorption spectrum properties with absorption regions within a range from 250 nm to 500 nm;

the polymerization initiating agent having an absorption region with a longer wavelength end wavelength longer than the longer wavelength end wavelength of the absorption region of the polymerizable compounds; and

exposure of the resist composition being executed by light having spectral intensity properties that satisfy Formula 1 below:

λb<λa≦λc (1)

wherein λa is a set light emission wavelength related to spectral intensity properties within light within a wavelength range from 250 nm to 500 nm irradiated during the exposure, and represents a set light emission wavelength toward the shorter wavelength end at which the light emission intensity is 10% with respect to the light emission intensity at a maximum peak wavelength;

λb is a set absorption wavelength related to the absorption spectrum properties of the polymerizable compounds, and represents a set absorption wavelength at the longer wavelength end at which light absorption is 10% with respect to light absorption at a maximum peak wavelength; and

λc is a set absorption wavelength related to the absorption spectrum properties of the polymerization initiating agent, and represents a set absorption wavelength at the longer wavelength end at which light absorption is 10% with respect to light absorption at a maximum peak wavelength.

In the present specification, the expression “light emission intensity at a maximum peak wavelength” refers to a maximal peak intensity from among one or more peak intensities observed within intensity spectrum properties in a wavelength range from 250 nm to 500 nm (in the case that there are no peaks, the maximum value within the wavelength range). Note that in the case that there are no peaks, the maximum value within the wavelength range is designated as the light emission intensity at the maximum peak wavelength.

The expression “light absorption at a maximum peak wavelength” refers to a maximal peak absorption intensity from among one or more peak absorption intensities observed within absorption spectrum properties in a wavelength range from 250 nm to 500 nm. Note that in the case that there are no peaks, the maximum value within the wavelength range is designated as the light absorption at the maximum peak wavelength.

In the nanoimprinting method of the present invention, it is preferable for:

the weighted average of the Ohnishi parameters related to all of the polymerizable compounds included in the resist composition to be 3.5 or less; and

the weighted average of the ring parameters related to all of the polymerizable compounds to be 0.3 or greater.

In the nanoimprinting method of the present invention, it is preferable for:

the Ohnishi parameter related to at least one of the polymerizable compounds included in the resist composition to be 3.5 or less, the ring parameter of the at least one polymerizable compound to be 0.3 or greater, and the at least one polymerizable compound to have an aromatic group.

In the nanoimprinting method of the present invention, it is preferable for:

the polymerizable compounds to include at least one compound selected from compounds represented by General Formula I and General Formula II below:

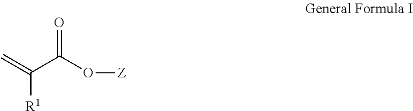

wherein Z represents a group that includes an aromatic group, and R¹ represents a hydrogen atom, an alkyl group, or a halogen atom.

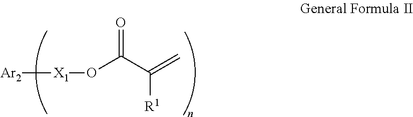

wherein Ar₂ represents a linking group having an aromatic group and a valence of n (n is an integer from 1 to 3), X₁ represents a single bond or a hydrocarbon group, and R¹ represents a hydrogen atom, an alkyl group, or a halogen atom.

In the nanoimprinting method of the present invention, it is preferable for:

the maximum peak wavelength of the absorption spectrum properties of the polymerization initiating agent to be 340 nm or greater.

In the nanoimprinting method of the present invention, it is preferable for:

the set light emission wavelength to be 340 nm or greater.

In the nanoimprinting method of the present invention, it is preferable for:

an exposure system for executing exposure to be equipped with an LED light source; and

the maximum peak wavelength in the spectral intensity properties of the light to be 350 nm or greater.

In the nanoimprinting method of the present invention, it is preferable for:

the exposure system to be equipped with a sharp cut filter having a transmissivity of 1% or less, at least with respect to light having a wavelength of 300 nm.

In the nanoimprinting method of the present invention, it is preferable for:

the exposure system to be equipped with a sharp cut filter having a transmissivity of 1% or less, at least with respect to light having a wavelength of 340 nm.

A resist composition of the present invention is a resist composition to be utilized in the nanoimprinting method of the present invention, wherein:

the resist composition includes polymerizable compounds and a polymerization initiating agent, each having absorption spectrum properties with absorption regions within a range from 250 nm to 500 nm; and

the polymerization initiating agent has an absorption region with a longer wavelength end wavelength longer than the longer wavelength end wavelength of the absorption region of the polymerizable compounds.

In the resist composition of the present invention, it is preferable for:

the weighted average of the Ohnishi parameters related to all of the polymerizable compounds included in the resist composition to be 3.5 or less; and

the weighted average of the ring parameters related to all of the polymerizable compounds to be 0.3 or greater.

In the resist composition of the present invention, it is preferable for:

the Ohnishi parameter related to at least one of the polymerizable compounds included in the resist composition to be 3.5 or less, the ring parameter of the at least one polymerizable compound to be 0.3 or greater, and the at least one polymerizable compound to have an aromatic group.

In the resist composition of the present invention, it is preferable for:

the polymerizable compounds to include at least one compound selected from compounds represented by General Formula I and General Formula II above.

In the resist composition of the present invention, it is preferable for:

the maximum peak wavelength of the absorption spectrum properties of the polymerization initiating agent to be 340 nm or greater.

The nanoimprinting method of the present invention employs the resist composition including polymerizable compounds and a polymerization initiating agent, each having absorption spectrum properties with absorption regions within a range from 250 nm to 500 nm; the polymerization initiating agent having an absorption region with a longer wavelength end wavelength longer than the longer wavelength end wavelength of the absorption region of the polymerizable compounds; and exposure of the resist composition being executed by light having spectral intensity properties that satisfy Formula 1 above. In this configuration, the absorption of light irradiated during exposure by the polymerizable compound can be reduced. If the light absorbed by the polymerizable compound is reduced, first, it becomes possible to suppress decomposition of the polymerizable compound. Second, it becomes possible for a greater amount of light to be absorbed by the polymerization initiating agent, for a polymerization reaction to progress more efficiently, and for the resist composition to be sufficiently cured. As a result, suppression of contamination of molds by adhered matter and formation of resist patterns having sufficient etching resistance becomes possible.

The resist composition of the present invention includes polymerizable compounds and a polymerization initiating agent, each having absorption spectrum properties with absorption regions within a range from 250 nm to 500 nm; and the polymerization initiating agent having an absorption region with a longer wavelength end wavelength longer than the longer wavelength end wavelength of the absorption region of the polymerizable compounds. This configuration enables execution of the nanoimprinting method of the present invention. Therefore, the resist composition of the present invention exhibits the same advantageous effects as those of the nanoimprinting method of the present invention.

### BRIEF DESCRIPTION OF THE DRAWINGS

FIG. 1 is a graph that illustrates the absorption spectrum properties of a polymerizable compound and a polymerization initiating agent and the intensity spectrumproperties of an exposure system of a comparative example.

FIG. 2 is a graph that illustrates the absorption spectrum properties of a polymerizable compound and a polymerization initiating agent and the intensity spectrumproperties of an exposure system of an embodiment of the present invention.

FIG. 3 is a graph that illustrates the absorption spectrum properties of a polymerizable compound and a polymerization initiating agent and the intensity spectrumproperties of an exposure system of another embodiment of the present invention.

FIG. 4 is a graph that illustrates the absorption spectrum properties of a polymerizable compound and a polymerization initiating agent and the intensity spectrum properties of an exposure system of still another embodiment of the present invention.

### BEST MODE FOR CARRYING OUT THE INVENTION

Hereinafter, embodiments of the present invention will be described with reference to the attached drawings. However, the present invention is not limited to the embodiments to be described below. Note that the dimensions, etc. of the constituent elements within the drawings are different from the actual dimensions in order to facilitate visual understanding.

A nanoimprinting method of an embodiment of the present invention comprises the steps of: employing a mold having a fine pattern of protrusions and recesses on a surface thereof; exposing a resist composition coated on a substrate to be processed while the resist composition is pressed with the pattern of protrusions and recesses, to cure the resist composition; and separating the mold from the resist composition; the resist composition including polymerizable compounds and a polymerization initiating agent, each having absorption spectrum properties with absorption regions within a range from 250 nm to 500 nm; the polymerization initiating agent having an absorption region with a longer wavelength end wavelength longer than the longer wavelength end wavelength of the absorption region of the polymerizable compounds; and exposure of the resist composition being executed by light having spectral intensity properties that satisfy Formula 2 below:

λb<λa≦λc (2)

wherein λa is a set light emission wavelength related to spectral intensity properties within light within a wavelength range from 250 nm. to 500 nm irradiated during the exposure, and represents a set light emission wavelength (set light emission wavelength) toward the shorter wavelength end at which the light emission intensity is 10% with respect to the light emission intensity at a maximum peak wavelength; λb is a set absorption wavelength related to the absorption spectrum properties of the polymerizable compounds, and represents a set absorption wavelength (first set absorption wavelength) at the longer wavelength end at which light absorption is 10% with respect to light absorption at a maximum peak wavelength; and λc is a set absorption wavelength related to the absorption spectrum properties of the polymerization initiating agent, and represents a set absorption wavelength (second set absorption wavelength) at the longer wavelength end at which light absorption is 10% with respect to light absorption at a maximum peak wavelength.

### (Mold)

Si is an example of the material of the mold. A Si mold is produced in the following matter, for example. First, Si base material is coated by a photoresist liquid having PMMA (Polymethyl Methacrylate) or the like as a main component by the spin coat method or the like, to form a photoresist layer. Next, an electron beam modulated corresponding to a predetermined line pattern is irradiated onto the Si base material while the Si base material is scanned on an XY stage, to expose a pattern of protrusions and recesses on the surface of the photoresist layer within a 10 mm square region. Thereafter, the photoresist layer is developed to remove the exposed portions. Finally, etching is performed to a predetermined depth using the photoresist layer after the exposed portions are removed as a mask, to obtain a Si mold having the pattern of protrusions and recesses.

Alternatively, a quartz substrate may be employed as the material of the mold 1. In the case that a fine pattern is to be formed on a quartz substrate, it is necessary to use a laminated structure constituted by a metal layer and a photoresist layer as the mask when processing the substrate. An example of a method for processing a quartz substrate is as follows. Dry etching is performed using a photoresist layer as a mask, to form a pattern of protrusions and recesses corresponding to a pattern of protrusions and recesses formed in the photoresist layer on a metal layer. Then, dry etching is further performed on the quartz substrate using the metal layer as an etching stop layer, to form a pattern of protrusions and recesses on the quartz substrate. Thereby, a quartz mold having a predetermined pattern is obtained. Alternatively, pattern transfer using imprinting may be performed instead of electron beam lithography, as a method for forming the pattern.

Further, the mold may be that which has undergone a mold release process to improve separation properties between the photocuring resin and the mold. Such a mold release process is executed employing silicone or fluorine silane coupling agents. Examples of silane coupling agents include Optool™ DSX by Daikin Industries K.K. and Novec™ EGC-1720 by Sumitomo 3M K.K. Alternatively, other commercially available mold release agents may be favorably employed.

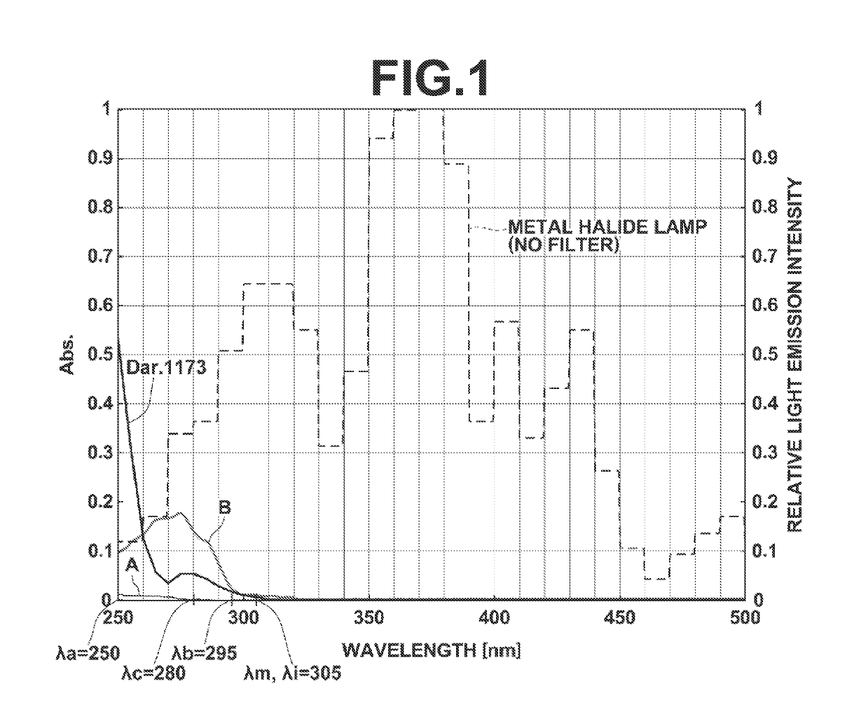

As alternatives to the aforementioned quartz, the material of the mold may be: a metal, such as silicon, nickel, aluminum, chrome, steel, tantalum, and tungsten; oxides, nitrides, and carbides of such metals; and resin. Specific examples of the material of the mold 1 include silicon oxide, aluminum oxide, quartz glass, Pyrex™, glass, and soda glass. The embodiment of FIG. 1 performs exposure through the mold. Therefore, the mold is formed by a light transmissive material. In the case that exposure is performed from the side of the substrate to be processed, it is not necessary for the material of the mold 1 to be light transmissive.

### (Substrate to be Processed)

The substrate to be processed is a substrate for imprinting on which resist is coated. Examples of the material of the substrate include nickel, aluminum, glass, and resin. These materials may be utilized singly or in combination. A resist pattern is formed on the substrate to be processed by nanoimprinting, and then dry etching is executed using the resist pattern as a mask, for example. A surface layer may be formed on the surface of the substrate to be processed. Provision of the surface layer can improve the processing properties of the substrate to be processed in a subsequent etching process. Examples of the surface layer include: metal layers, metal oxide layers, and resin layers. In addition, a close contact layer may be formed on the surface of the substrate to be processed. Provision of the close contact layer can suppress peeling of the resist pattern during a nanoimprinting step, enabling favorable pattern formation to be executed.

### (Resist Composition)

The resist composition of the present invention includes at least (A) at least one type of polymerizable compound A and (B) a polymerization initiating agent. In addition, (C) other polymerizable compounds C and (D) other components may also be included as appropriate.

From among the polymerizable compounds that constitute the resist composition, the at least one type of polymerizable compound A and the polymerization initiating agent have absorption spectrum properties with absorption regions within a range from 250 nm to 500 nm. In the present specification, the expression “absorption regions” refers to wavelength ranges within a range from 250 nm to 500 nm at which the degree of light absorption is 0.01 or greater.

In the case that other polymerizable compounds C are included, the polymerizable compounds C may or may not have absorption spectrum properties with absorption regions within a range from 250 nm to 500 nm.

The degree of light absorption can be obtained from a light absorption spectrum, which is calculated from a transmissivity of a spectral absorption spectrum at an optical path length of 10 mm for a 0.001% by mass acetonitryl solution of a target solute (polymerizable compounds, polymerization initiating agents, etc.).

The polymerization initiating agent has an absorption region with a longer wavelength end wavelength λi longer than the longer wavelength end wavelength λm of the absorption region of the polymerizable compounds (including other polymerizable compounds C having absorption spectrum properties having absorption regions within a wavelength range from 250 nm to 500 nm). The expression “longer wavelength end wavelength” refers to a wavelength at the longer wavelength end within a wavelength range from 250 nm to 500 nm at which the degree of light absorption is 0.01, that is, a wavelength at the longer wavelength end of the absorption region.

In the present invention, it is preferable for the set light emission wavelength λa of the exposure system to be greater than the set absorption wavelength λb of the polymerizable compounds, and for the set light emission wavelength λa to be greater than the longer wavelength end wavelength λm of the polymerizable compounds. By satisfying these conditions, absorption of the light emitted by the exposure system by the polymerizable compounds can be suppressed. As a result, decomposition of the polymerizable compound A during the nanoimprinting process can be suppressed, and contamination of the mold due to accumulation of adhered matter thereon can be greatly suppressed.

Note that in the case that the resist composition includes a plurality of types of polymerizable compounds and a plurality of types of polymerization initiators, Formula 2 above need only be satisfied by one pair of a polymerizable compound and a polymerization initiating agent. Note that the most preferred mode of the present invention is that in which Formula 2 above is satisfied when the longest set absorption wavelength from among the set absorption wavelengths of each of the plurality of types of polymerizable compounds according to the above definition is designated as λb, and the shortest set absorption wavelength from among the set absorption wavelengths of each of the plurality of types of polymerization initiating agents according to the above definition is designated as λc.

It is preferable for an average Ohnishi parameter value of the polymerizable compounds (all polymerizable compounds, including the at least one type of polymerizable compound A and other polymerizable compounds C) that constitute the resist composition, obtained by calculating a weighted average of the Ohnishi parameters of each of the polymerized compounds, to be 3.5 or less. It is also preferable for an average ring parameter value (a weighted average of the ring parameters of each of the polymerized compounds) obtained in the same manner to be 0.3 or greater. In the present invention, these parameter values were designated as formulation parameter values.

The Ohnishi parameter is a parameter that empirically indicates the chemical resistance of compounds with respect to dry etching, and is calculated by the formula:

Total Number of Atoms/(Number of Carbon Atoms−Number of Oxygen Atoms)

Meanwhile, the ring parameter is a parameter that empirically indicates the physical resistance of compounds with respect to dry etching, and is calculated by the formula:

Mass of Carbon Having Ring Structures/Total Mass

Note that in the present invention, nitrogen atoms and sulfur atoms are counted as ½ the number of oxygen atoms. It becomes possible to further improve etching resistance, by the parameters satisfying the above conditions.

### (A: Polymerizable Compound A)

It is preferable for the polymerizable compound A to be a polymerizable compound having an aromatic group with an Ohnishi parameter value of 3.5 or less and a ring parameter of 0.3 or greater. By employing a polymerizable compound having an aromatic group, the line edge roughness will become favorable when the polymerizable compound is employed as an etching resist for substrates to be processed.

It is preferable for the polymerizable compound having the aromatic group to be employed in the present invention to be a monofunctional (meth)acrylate compound represented by General Formula I below or a polyfunctional (meth)acrylate compound represented by General Formula II below.

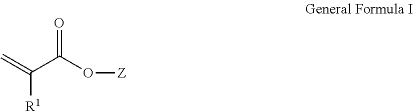

In General Formula I, Z represents a group that includes an aromatic group, and R¹ represents a hydrogen atom, an alkyl group, or a halogen atom.

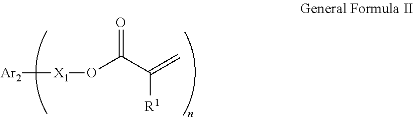

In General Formula II, Ar₂ represents a linking group having an aromatic group and a valence of n (n is an integer from 1 to 3), X₁ represents a single bond or a hydrocarbon group, and R¹ represents a hydrogen atom, an alkyl group, or a halogen atom.

The monofunctional (meth)acrylate compound represented by General Formula I and the polyfunctional (meth)acrylate compound represented by General II will be described in detail below.

### <Monofunctional (Meth)Acrylate Compound>

In General Formula I, R¹ preferably represents an alkyl group or a halogen atom, preferably a halogen atom or a methyl group, and most preferably a halogen atom from the viewpoint of curing properties. Preferred examples of the halogen atom include: a fluorine atom; a chlorine atom; a bromine atom; and an iodine atom. It is particularly preferable for R¹ to be a fluorine atom.

It is preferable for Z to be an aralkyl group that may have substituent groups, an aryl group that may have substituent groups, or such groups which are bonded via a linking group. here, the linking group may include a linking group that includes a hetero atom. Preferred examples of such a linking group are: —CH₂—, —O—, —C(═O)—, —S—, and combinations thereof. It is preferable for the aromatic group included in Z to be a phenyl group or a naphthyl group. It is preferable for the molecular weight of Z to be within a range from 90 to 300, and more preferably within a range from 120 to 250.

It is preferable for the viscosity of the polymerizable compound represented by General Formula I as a liquid at 25° C. to be within a range from 2 mPa·s to 500 mPa·s, more preferably within a range from 3 mPa·s to 200 mPa·s, and most preferably within a range from 3 mPa·s to 100 mPa·s. It is preferable for the polymerizable compound to be a liquid at 25° C. If the polymerizable compound is a solid at 25° C., it is preferable for the melting point thereof to be 60° C. or less, more preferable for the melting point to be 40° C. or less, and most preferable for the polymerizable compound to be a liquid at 25° C.

It is preferable for Z to be a group represented by —Z₁-Z₂. Here, Z₁ is a single bond or a hydrocarbon group. The hydrocarbon group may include a linking group that has a hetero atom. Z₂ is an aromatic group that may have a substituent group and a molecular weight of 90 or greater.

It is preferable for Z₁ to be a single bond or an alkylene group. The alkylene group may include a linking group that has a hetero atom in a chain thereof. It is more preferable for Z₁ to be an alkylene group that does not include a linking group having a hetero atom in a chain thereof. It is most preferable for Z₁ to be a methylene group or an ethylene group. Examples of linking groups that have hetero atoms include: —O—; —C(═O)—; —S—, and combinations of these linking groups with alkylene groups. In addition, it is preferable for the carbon number of the hydrocarbon group to be within a range from 1 to 3.

It is preferable for Z₂ to be a group in which two or more aromatic groups are directly bonded or bonded via linking groups. In this case as well, preferred examples of the linking groups are: —CH₂—, —O—, —C(═O)—, —S—, and combinations thereof.

Examples of the substituent groups that the aromatic group that the polymerizable compound represented by General Formula I may have include: halogen atoms (fluorine atoms, chloro atoms, bromine atoms, iodine atoms); straight chain, branched, or ring shaped alkyl groups; alkenyl groups; alkynyl groups; aryl groups; acyl groups; alkoxy carbonyl groups; aryloxycarbonyl groups; carbamoyl groups; cyano groups; carboxyl groups; hydroxy groups; alkoxy groups; aryloxy groups; alkylthio groups; arylthio groups; heterocyclic oxy groups; acyloxy groups; amino groups; nitro groups; hydrazine groups; and heterocyclic groups. In addition, groups which are further substituted by these groups are also preferable.

The amount of the polymerizable compound represented by General Formula I to be included in the photocurable composition is preferably within a range from 10% by mass to 100% by mass, more preferably within a range from 20% by mass to 100% by mass, and most preferably within a range from 30% by mass to 80% by mass.

Specific examples of compounds that do not have substituent groups in an aromatic ring, from among the polymerizable compounds represented by General Formula I include: benzyl (meth)acrylate; phenethyl (meth)acrylate; phenoxyethyl (meth)acrylate; 1- or 2-naphthyl(meth)acrylate; 1- or 2-naphthylmethyl (meth)acrylate; 1- or 2-naphthylethyl (meth)acrylate; and 1- or 2-naphthoxyethyl (meth)acrylate.

Compounds having a substituent group on an aromatic ring represented by General Formula I-1 below are also preferable as the polymerizable compound represented by General Formula I.

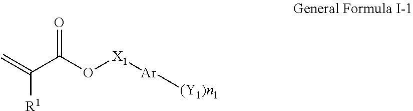

In General Formula I-1, R¹ represents a hydrogen atom, an alkyl group, or a halogen atom, and X₁ represents a single bond or a hydrocarbon group, the hydrocarbon group may include a linking group having a hetero atom in a chain thereof. Y₁ represents a substituent group having a molecular weight of 15 or greater, and n₁ represents an integer within a range from 1 to 3. Ar represents an aromatic linking group, and is preferably a phenylene group or a naphthylene group.

R¹ in General Formula (I-1) is the same as R¹ in General Formula I, and the preferable range thereof is the same as that in General Formula I.

X₁ in General Formula (I-1) is the same as Z₁ in General Formula I, and the preferable range thereof is the same as that in General Formula I.

Y₁ represents a substituent group having a molecular weight of 15 or greater. Examples of such substituent groups include: alkyl groups; alkoxy groups; aryloxy groups; aralkyl groups; acyl groups; alkoxy carbonyl groups; alkylthio groups; arylthio groups; halogen atoms; and cyano groups. These substituent groups may further have substituent groups.

It is preferable for X₁ to be a single bond or a hydrocarbon group having a carbon number of 1 when n₁ is 2.

It is particularly preferable for n₁ to be 1, and X₁ to be an alkylene group having a carbon number within a range from 1 to 3.

It is more preferable for the compound represented by General Formula I-1 to be a compound represented by General Formula I-2 or General Formula I-3.

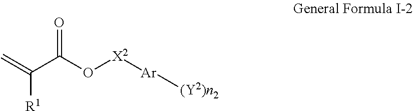

In general Formula I-2, R¹ represents a hydrogen atom, an alkyl group, or a halogen atom, and X² represents a single bond or a hydrocarbon group, the hydrocarbon group may include a linking group having a hetero atom in a chain thereof. Y² represents a substituent group without an aromatic group having a molecular weight of 15 or greater, and n₂ represents an integer within a range from 1 to 3.

R¹ in General Formula (I-2) is the same as R¹ in General Formula I, and the preferable range thereof is the same as that in General Formula I.

In the case that X² is a hydrocarbon group, it is preferable for the hydrocarbon group to have a carbon number within a range from 1 to 3. It is preferable for X² to be a substituted or a non substituted alkylene group having a carbon number of 1 through 3, more preferable for X² to be a non substituted alkylene group having a carbon number of 1 through 3, and most preferable for X² to be a methylene group or an ethylene group. By employing such a hydrocarbon group, the photocuring composition can have lower viscosity and low volatility.

Y² represents a substituent group without an aromatic group having a molecular weight of 15 or greater. It is preferable for the molecular weight of Y² to be 150 or less. Examples of Y² include: alkyl groups having carbon numbers within a range from 1 to 6, such as isopropyl groups, tert-butyl groups, and cyclohexyl groups; halogen atoms, such as fluoro groups, chloro groups, and bromo groups; alkoxy groups having carbon numbers within a range from 1 to 6, such as methoxy groups, ethoxy groups, and cyclohexyloxy groups; and cyano groups.

It is preferable for n₂ to be an integer within a range from 1 to 2. It is preferable for substituent group Y to be at a para position in the case that n₂ is 1. It is preferable for X² to be a single bond or a hydrocarbon group having a carbon number of 1 in the case that n₂ is 2, from the viewpoint of viscosity.

It is preferable for the molecular weight of the (meth)acrylate compound represented by General Formula I-2 to be within a range from 175 to 250, and more preferably within a range from 185 to 245, in order to realize both low viscosity and low volatility.

It is preferable for the viscosity of the (meth)acrylate compound represented by General Formula I-2 to be 50 mPa·s or less at 25° C., and more preferably 20 mPa·s or less.

The compound represented by General Formula I-2 may also be favorably employed as a reaction diluting agent.

The amount of the compound represented by General Formula I-2 to be included in the photocurable composition is preferably 10% by mass or greater, more preferably 15% by mass or greater, and most preferably 20% by mass or greater, from the viewpoint of the viscosity of the composition and pattern prevision following curing. Meanwhile, it is preferable for the amount of the compound represented by General Formula I-2 to be included in the photocurable composition to be 95% by mass or less, more preferably 90% by mass or less, and most preferably 85% by mass or less, from the viewpoint of tackiness and dynamic strength following curing.

Examples of compounds represented by General Formula I-2 will be indicated below. However, it goes without saying that the present invention is not limited to these compounds.

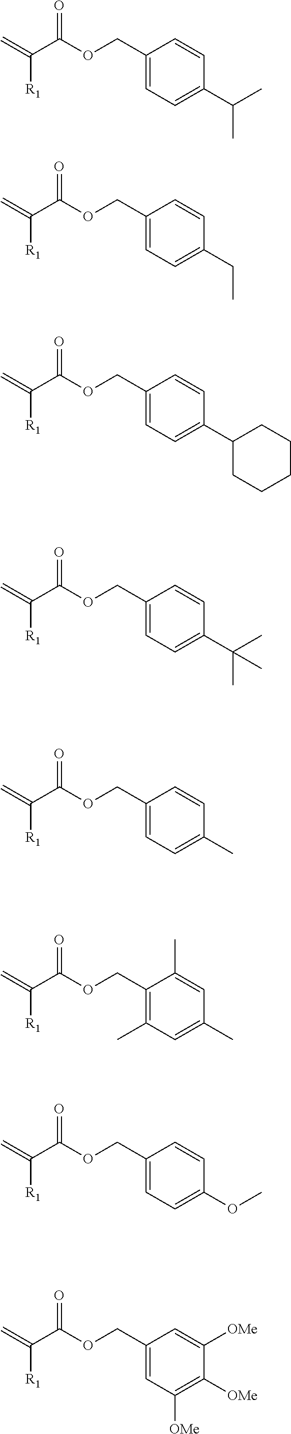

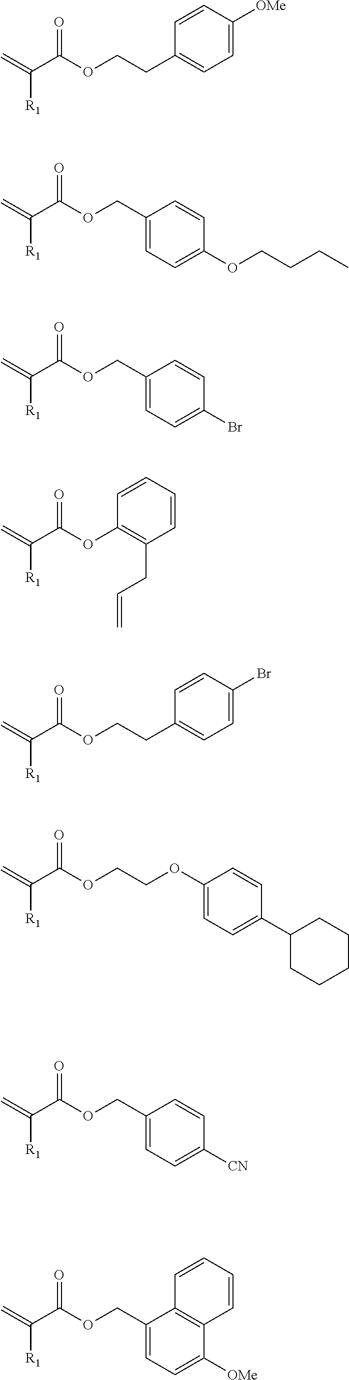

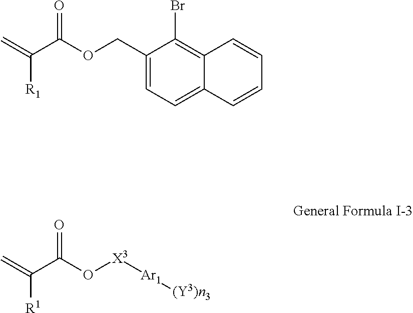

In General Formula I-3, R¹ represents a hydrogen atom, an alkyl group, or a halogen atom. X³ represents a single bond or a hydrocarbon group, which may include a linking group having a hetero atom in a chain thereof. Y³ represents a substituent group with an aromatic group, and n₃ represents an integer within a range from 1 to 3.

R¹ in General Formula (I-3) is the same as R¹ in General Formula I, and the preferable range thereof is the same as that in General Formula I.

Y³ represents a substituent group with an aromatic group. It is preferable for substituent group with an aromatic group to be that in which an aromatic group is bonded to the aromatic ring of General Formula I-3 via a single bond or a linking group. Preferred examples of the linking group include: alkylene groups; linking groups having hetero atoms (preferably —O—, —S—, —C(═O)O—), and combinations thereof. It is preferable for the substituent group with an aromatic group to be a substituent group with a phenyl group. It is preferable for the phenyl group to be bonded via a single bond or the aforementioned linking group, and phenyl groups, benzyl groups, phenoxy groups, benzyloxy groups, and phenylthio groups are particularly preferred. It is preferable for the molecular weight of Y³ to be within a range from 230 to 350.

It is preferable for n₃ to be 1 or 2, and more preferably 1.

The amount of the compound represented by General Formula I-3 to be included in the photocurable composition is preferably 10% by mass or greater, more preferably 20% by mass or greater, and most preferably 30% by mass or greater. Meanwhile, it is preferable for the amount of the compound represented by General Formula I-3 to be included in the photocurable composition to be 90% by mass or less, more preferably 80% by mass or less, and most preferably 70% by mass or less, from the viewpoint of tackiness and dynamic strength following curing.

Examples of compounds represented by General Formula I-3 will be indicated below. However, it goes without saying that the present invention is not limited to these compounds.

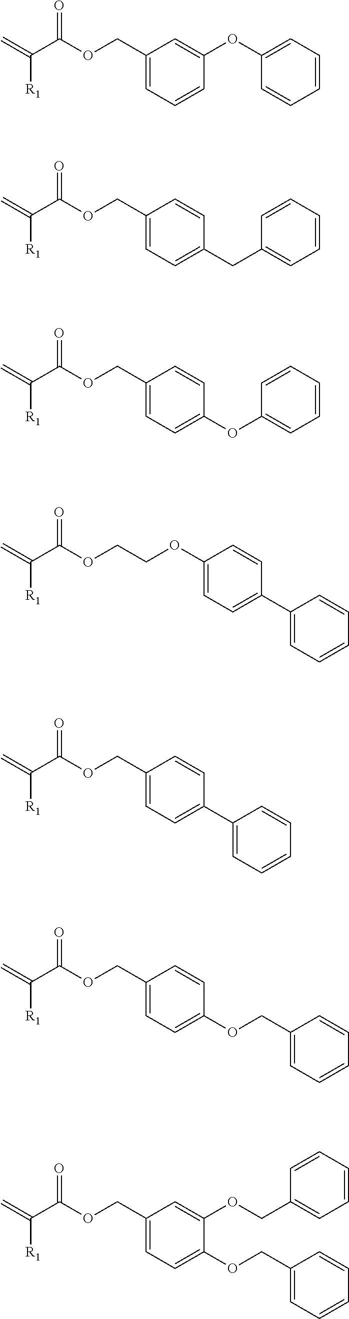

### <Polyfunctional (Meth)Acrylate Compound>

In General Formula II, Ar₂ represents a linking group having an aromatic group, and is preferably a linking group having a phenylene group. X₂ and R¹ are the same as those of General Formula I. n represents an integer from 1 to 3, and is preferably 1.

It is preferable for the compound represented by General Formula II to be a compound represented by General Formula II-1 or General Formula II-2 below.

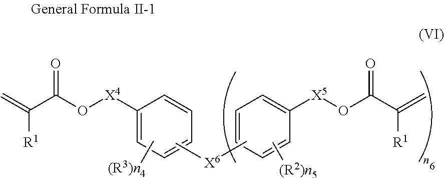

In General Formula II-1, X⁶ represents a single bond or a linking group having a valence of (n₆+1), and each R¹ represents a hydrogen atom, an alkyl group, or a halogen atom. R² and R³ are substituent groups, and n₄ and n₅ represent integers within a range from 0 to 4. n₆ represents 1 or 2. X⁴ and X⁵ each represent a hydrocarbon group, which may include a linking group having a hetero atom in a chain thereof.

It is preferable for X⁶ to be an alkylene group, —O—, —S—. —C(═O)O—, or linking groups which are combinations thereof. It is preferable for the alkylene group to be an alkylene group having a carbon number within a range from 1 to 8, and more preferably an alkylene group having a carbon number within a range from 1 to 3. In addition, a non substituted alkylene group is preferred.

It is preferable for n₆ to be 1. The plurality of R¹, X⁵, and R² which are present when n₆ is 2 may be the same or different.

It is preferable for X⁴ and X⁵ to be alkylene groups that do not include linking groups, more preferably alkylene groups having a carbon number within a range from 1 to 5, still more preferably alkylene groups having a carbon number within a range from 1 to 3 and most preferably methylene groups.

R¹ is the same as R¹ of General Formula I, and the preferable range thereof is also the same.

R² and R³ represent substituent groups, preferred examples of which include: alkyl groups; halogen atoms; alkoxy groups; acyl groups; acyloxy groups; alkoxy carbonyl groups; cyano groups; and nitro groups. It is preferable for the alkyl groups to be those having a carbon number within a range from 1 to 8. Examples of halogen atoms include: fluorine atoms; chlorine atoms; bromine atoms; and iodine atoms; among which fluorine atoms are preferred. It is preferable for the alkoxy groups to be those having a carbon number within a range from 1 to 8. It is preferable for the acyl groups to be those having a carbon number within a range from 1 to 8. It is preferable for the acyloxy groups to be those having a carbon number within a range from 1 to 8. It is preferable for the alkoxy carbonyl groups to be those having a carbon number within a range from 1 to 8.

Each of n₄ and n₅ represent an integer within a range from 1 to 4. When n₄ or n₅ are 2 or greater, the plurality of R² and R³ which are present may be the same or different.

It is preferable for the compound represented by General Formula II-1 to be a compound represented by General Formula II-1a below.

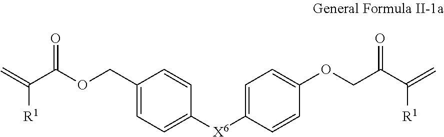

In General Formula II-1a, X⁶ represents an alkylene group, —O—, —S—, and linking groups which are combinations of a plurality of the above. Each R² represents a hydrogen atom, an alkyl group, or a halogen atom.

R² is the same as R² of General Formula I, and the preferred range thereof is also the same.

In the case that X⁶ is an alkylene group, it is preferable for the alkylene group to be an alkylene group having a carbon number within a range from 1 to 8, and more preferably an alkylene group having a carbon number within a range from 1 to 3.

—CH₂—, —CH₂CH₂—, —O— and —S— are preferred as X⁶.

The amount of the compound represented by General Formula II-1 to be included in the photocurable composition employed in the present invention is not particularly limited. However, it is preferable for the amount to be within a range from 1% by mass to 100% by mass with respect to the total mass of the polymerizable compounds, more preferably within a range from 5% by mass to 70% by mass, and most preferably within a range from 10% by mass to 50% by mass.

Examples of compounds represented by General Formula II-1 will be indicated below. It goes without saying that the present invention is not limited to these compounds. R¹ in the following chemical formulas are the same as R¹ of General Formula II-1, and the preferred ranges thereof are also the same. It is particularly preferable for R¹ to be hydrogen atoms.

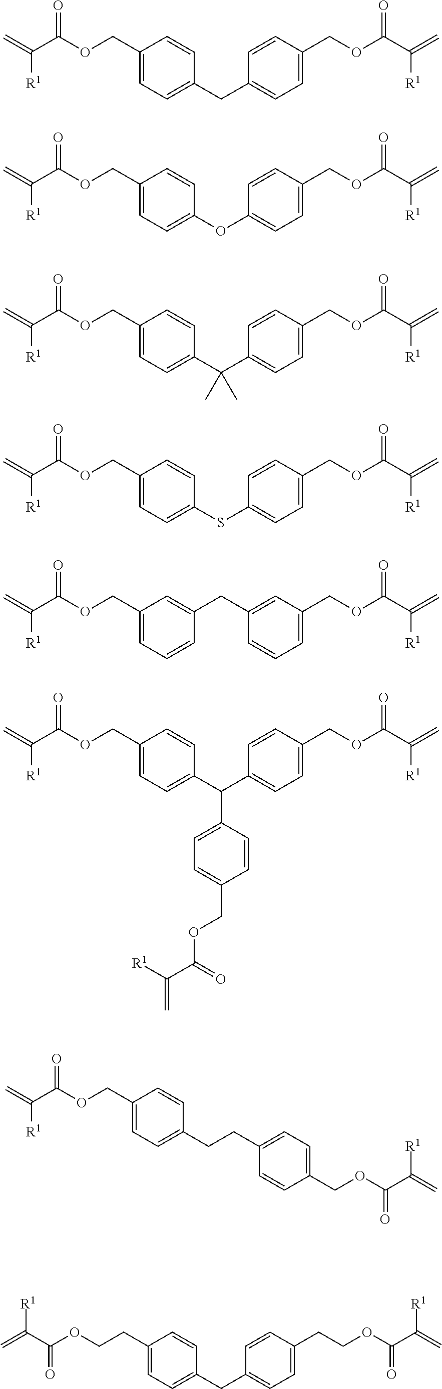

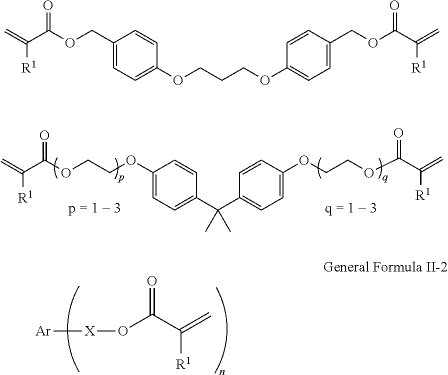

In general Formula II-2, Ar represents an arylene group that may have a substituent group, X represents a single bond or an organic linking group, R¹ represents a hydrogen atom or a methyl group and n represents either 2 or 3.

Examples of arylene groups include hydrocarbon series arylene groups, such as phenylene groups and naphthylene groups, and hetero arylene groups such as those having indole and carbazole as linking groups. Hydrocarbon series arylene groups are preferable, and among hydrocarbon series arylene groups, phenylene groups are more preferable from the viewpoint of viscosity and etching resistance. The arylene groups may have substituent groups. Preferred examples of substituent groups include: alkyl groups, alkoxy groups, hydroxyl groups, cyano groups, alkoxy carbonyl groups, amide groups, and sulfonic amide groups.

Examples of the organic linking group represented by X include alkylene groups, arylene groups, and aralkylen groups that may include hetero atoms within chains. From among such organic linking groups, alkylene groups and oxyalkylene groups are preferable, and alkylene groups are more preferable. It is particularly preferable for X to be a single bond or an alkylene group.

R¹ is preferably a hydrogen atom or a methyl group, and more preferably a hydrogen atom.

n is 2 or 3, and preferably 2.

It is preferable for the polymerizable compound II-2 to be a polymerizable compound represented by General Formula II-2a or General Formula II-2b below.

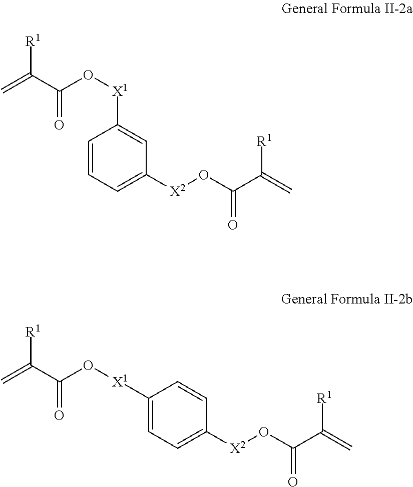

In General Formula II-2a, X¹ and X² respectively represent a single bond or an alkylene group with a carbon number from 1 to 3 that may have substituent groups, and R¹ represents a hydrogen atom or a methyl group.

In General Formula II-2a, X¹ is preferably a single bond or a methylene group, and more preferably a methylene group from the viewpoint of lowering viscosity.

The preferable range of X² is the same as that for X¹.

R¹ in General Formula II-2a is the same as R¹ in General Formula II, and the preferable range thereof is the same as that in General Formula II.

It is preferable for the above polymerizable compound to be a liquid at 25° C., because generation of foreign matter can be suppressed even when the amount thereof to be added is increased.

Specific examples of the polymerizable compound represented by General Formula II-2 will be indicated below. R¹ in the chemical formulas indicated below are the same as R¹ in General Formula II, and represents a hydrogen atom or a methyl group. Note that the present invention is not limited to these specific examples.

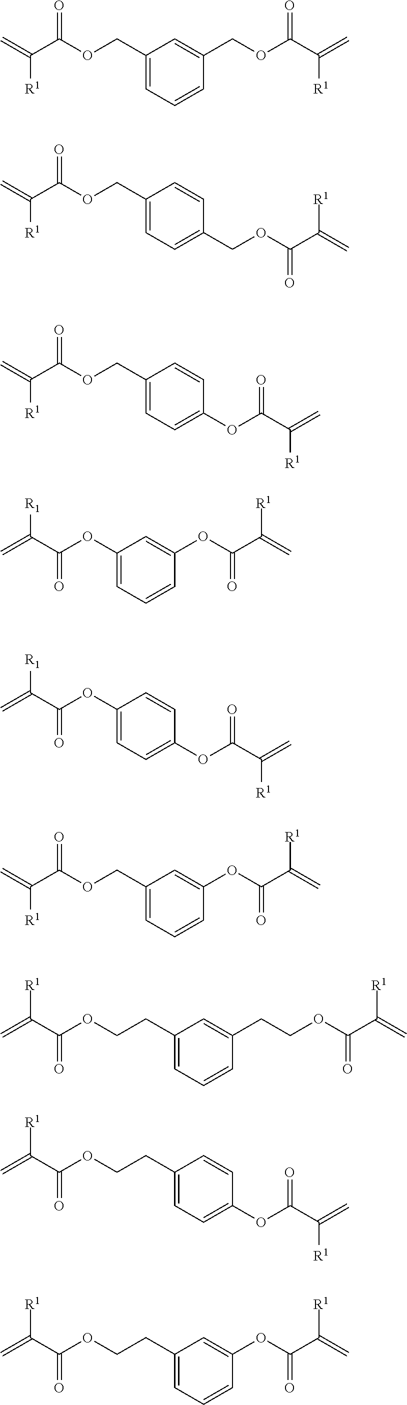

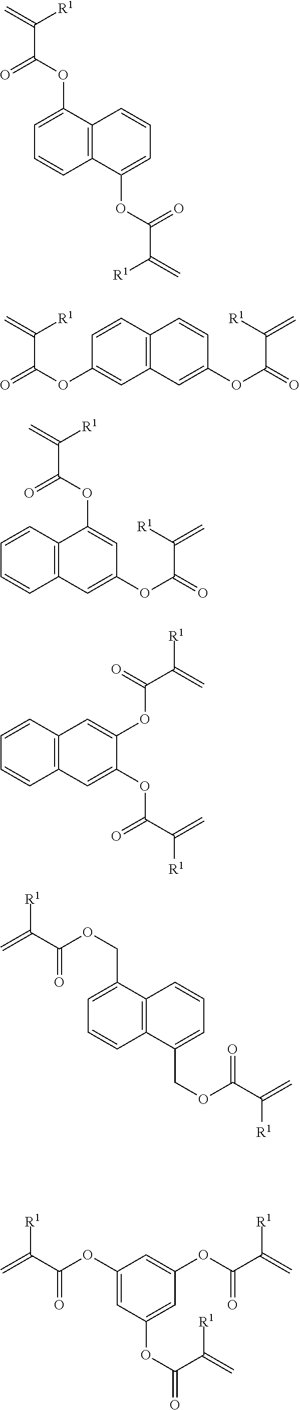

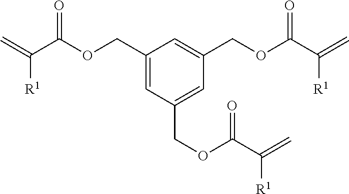

Hereinafter, specific examples of more preferred polymerizable compounds having aromatic groups for use in the photocurable composition employed in the present invention will be described. However, the present invention is not limited to these examples.

Benzyl (meth)acrylate, which is non substituted or has a substituent group on an aromatic ring; phenethyl (meth)acrylate, which is non substituted or has a substituent group on an aromatic ring; phenoxyethyl (meth)acrylate, which is non substituted or has a substituent group on an aromatic ring; 1- or 2-naphthyl(meth)acrylate, which is non substituted or has a substituent group on an aromatic ring; 1- or 2-naphthylmethyl (meth)acrylate, which is non substituted or has a substituent group on an aromatic ring; 1- or 2-naphthylethyl (meth)acrylate, which is non substituted or has a substituent group on an aromatic ring; 1- or 2-naphthoxyethyl (meth)acrylate; resorcinol di(meth)acrylate; m-xylylene di(meth)acrylate; naphthalene di(meth)acrylate; and ethoxylated bisphenol A diacrylate are preferred examples of the polymerizable compound for use in the photocurable composition employed in the present invention. Among these, benzyl (meth)acrylate, which is non substituted or has a substituent group on an aromatic ring, 1- or 2-naphthylmethyl acrylate, and m-xylylene diacrylate are particularly preferable.

Examples of other polymerizable compounds having aromatic groups include: ethoxylated phenyl(meth)acrylate; nonylphenoxypolyethylene glycol(meth)acrylate; nonylphenoxypolypropylene glycol(meth)acrylate; paracumylphenoxyethylene glycol(meth)acrylate; epichlorohydrine (hereinafter, referred to as “ECH”) denatured phenoxy acrylate; phenoxydiethylene glycol(meth)acrylate; phenoxyhexaethylene glycol(meth)acrylate; phenoxytetraethylene glycol(meth)acrylate; tribromophenyl(meth)acrylate; EO denatured tribromophenyl(meth)acrylate; p-isopropenyl phenol; EO denatured bisphenol A di(meth)acrylate; PO denatured bisphenol A di(meth)acrylate; denatured bisphenol A di(meth)acrylate; EO denatured bisphenol F di(meth)acrylate; o-, m-, p-benzene di(meth)acrylate; and o-, m-, p-xylylene di(meth)acrylate.

In the present invention, other preferred examples of polymerizable compounds having aromatic groups for use as the polymerizable compound A include: compounds with oxirane rings having aromatic groups (epoxy compounds); vinyl ether compounds including aromatic groups; and styrene derivatives.

<Compounds with Oxirane Rings Having Aromatic Groups (Epoxy Compounds)>

Examples of compounds with oxirane rings having aromatic groups (epoxy compounds) include: bisphenol A diglycidyl ether; bisphenol F diglycidyl ether; bisphenol S diglycidyl ether; brominated bisphenol A diglycidyl ether; brominated bisphenol F diglycidyl ether; brominated bisphenol S diglycidyl ether; hydrogenated bisphenol A diglycidyl ether; hydrogenated bisphenol F diglycidyl ether; and hydrogenated bisphenol S diglycidyl ether. In addition, monoglycidyl ethers of polyether alcohols, obtained from phenols, cresols, butylphenols or by adding alkylene oxide to phenols, cresols, or butylphenols are also examples of compounds with oxirane rings having aromatic groups (epoxy compounds).

The methods by which the compounds having oxirane rings are produced are not limited. These compounds may be synthesized by referring to the disclosures of: Y. Ito et al., “20 Organic Syntheses II”, Experimental Chemistry Lessons, pp. 213-225, 1992, Maruzen K. K. Press; A. Hasfner, “The Chemistry of Heterocyclic Compounds: Small Ring Heterocycles Part 3: Oxiranes”, Vol. 42, pp. 1-196, 1985, John Wiley and Sons, An Interscience Publication, New York; Yoshimura, “Adhesives”, Vol. 29, No. 12, pp. 32-38, 1985; Yoshimura, “Adhesives”, Vol. 30, No. 5, pp. 43-46, 1986, Yoshimura, “Adhesives”, Vol. 30, No. 7, pp. 42-46, 1986; Japanese Unexamined Patent Publication No. 11 (1999)-100378; Japanese Patent No. 2906245; and Japanese Patent No. 2926262.

### <Vinyl Ether Compounds Having Aromatic Groups>

Examples of vinyl ether compounds having aromatic groups include: 1,1,1-tris[4-(2-vinyloxyethoxy)phenyl]ethane; and bisphenol A divinyloxyethyl ether.

These vinyl ether compounds may be synthesized by the method disclosed in S. C. Lapin, Polymers Paint Colour Journal, Vol. 179, No. 4237, p. 321, 1988. That is, the vinyl ether compounds may be synthesized by a reaction between a multivalent alcohol or a multivalent phenol and acetylene, or by a reaction between a multivalent alcohol or a multivalent phenol and halogenated alkyl vinyl ether. The vinyl ether compounds may be used either singly or in combinations of two or more.

### <Styrene Derivatives>

Examples of styrene derivatives include: styrene; p-methyl styrene; p-methoxy styrene; β-methyl styrene; p-methyl-β-methyl styrene; α-methyl styrene; p-methoxy-β-methyl styrene; and p-hydroxy styrene.

### (C: Other Polymerizable Compounds)

The resist composition of the present invention may also include other polymerizable compounds C in order to improve the handling properties of the resist composition from the viewpoints of viscosity, volatility, and solubility, to improve the film quality of cured resist film, to ameliorate mold release defects during the nanoimprinting process, or to improve process durability during subsequent steps. Examples of the other polymerizable compounds C include: polymerizable compounds having aliphatic hydrocarbon structures; aliphatic polymerizable unsaturated monomers having 1 to 6 ethylene unsaturated bond containing groups; epoxy compounds; oxetane compounds; vinyl ether compounds; propenyl ether; and butenyl ether.

Examples of the polymerizable compounds having aliphatic hydrocarbon structures include monofunctional (meth)acrylates having aliphatic hydrocarbon structures and polyfunctional (meth)acrylates having aliphatic hydrocarbon structures. Examples of the monofunctional (meth)acrylates having aliphatic hydrocarbon structures include: cyclohexyl(meth)acrylate; isobornyl(meth)acrylate; dicyclopentanyl(meth)acrylate; dicyclopentanyloxyethyl (meth)acrylate; dicyclopentanyl(meth)acrylate; adamantyl(meth)acrylate; tricyclodecanyl(meth)acrylate; and tetracyclodecanyl(meth)acrylate. Meanwhile, examples of polyfunctional (meth)acrylates having aliphatic hydrocarbon structures include: tricyclodecane dimethanol di(meth)acrylate; 1,3-adamantandiol di(meth)acrylate; dimethylol dicyclopentane di(meth)acrylate; dimethylol tricyclodecane di(meth)acrylate; and norbornane di methanol di(meth)acrylate.

The polymerizable unsaturated monomers having groups with 1 to 6 ethylene unsaturated bonds (polymerizable unsaturated monomers having 1 to 6 functions) that can also be included will be described.

First, specific examples of polymerizable unsaturated monomers having groups with 1 ethylene unsaturated bond include: methyl (meth)acrylate; ethyl (meth)acrylate; butyl (meth)acrylate; 2-acryloyloxy ethylphthalate; 2-acryloyloxy 2-hydroxyethylphthalate; 2-acryloyloxy ethylhexahydrophthalate; 2-acryloyloxy propylphthalate; 2-ethyl-2-butylpropanediol acrylate; 2-ethylhexyl(meth)acrylate; 2-ethylhexyl carbitol(meth)acrylate; 2-hydroxybutyl (meth)acrylate; 2-hydroxyethyl (meth)acrylate; 2-hydroxypropyl(meth)acrylate; 4-hydroxybutyl (meth)acrylate; acrylic acid dimer; butoxyethyl (meth)acrylate; butyl (meth)acrylate; cetyl(meth)acrylate; denatured ethylene oxide (hereinafter, referred to as “EO”); cresol(meth)acrylate; dipropylene glycol(meth)acrylate; ethyl (meth)acrylate; isooctyl(meth)acrylate; isomyristyl(meth)acrylate; lauryl(meth)acrylate; methoxydipropylene glycol(meth)acrylate; methoxytripropylene glycol(meth)acrylate; methoxypolyethylene glycol(meth)acrylate; methoxytriethylene glycol(meth)acrylate; neopentylglycolbenzoate(meth)acrylate; octyl(meth)acrylate; polyethylene glycol(meth)acrylate; polyethylene glycol-polypropylene glycol(meth)acrylate; polypropylene glycol(meth)acrylate; stearyl(meth)acrylate; EO denatured succinate (meth)acrylate; tridodecyl(meth)acrylate.

In the present invention, polyfunctional polymerizable unsaturated monomers having groups that include two ethylene unsaturated bonds are also preferred as polymerizable compounds.

Specific examples of polymerizable unsaturated monomers having groups with 2 ethylene unsaturated bonds include: diethylene glycol monoethylether(meth)acrylate; dimethylol dicyclopentane di(meth)acrylate; di(meth)acrylated isocyanulate; 1,3-butyrene glycol di(meth)acrylate; 1,4-butanediol di(meth)acrylate; EO denatured 1,6-hexanediol di(meth)acrylate; ECH denatured 1,6-hexanediol di(meth)acrylate; aryloxy polyethylene glycol acrylate; 1,9-nonanediol di(meth)acrylate; EO denatured bisphenol A di(meth)acrylate; PO denatured bisphenol A di(meth)acrylate; denatured bisphenol A di(meth)acrylate; EO denatured bisphenol F di(meth)acrylate; ECH denatured hexahydrophthalic diacrylate; hydroxypivalate neopentyl glycol di(meth)acrylate; neopentyl glycol di(meth)acrylate; EO denatured neopentyl glycol diacrylate; propylene oxide (hereinafter, referred to as “PO”) denatured neopentyl glycol diacrylate; caprolactone denatured hydroxypivalate ester neopentyl glycol; stearic acid denatured pentaerythritol di(meth)acrylate; ECH denatured phthalate di(meth)acrylate; poly(ethylene glycol-tetramethylene glycol)di(meth)acrylate; poly(propylene glycol-tetramethylene glycol)di(meth)acrylate; polyester (di) acrylate; polyethylene glycol di(meth)acrylate; polypropylene glycol di(meth)acrylate; ECH denatured propylene glycol di(meth)acrylate; silicone di(meth)acrylate; triethylene glycol di(meth)acrylate; tetraethylene glycol di(meth)acrylate; dimethylol tricyclodecane di(meth)acrylate; neopentyl glycol denatured trimethylol propane di(meth)acrylate; tripropylene glycol di(meth)acrylate; EO denatured tripropylene glycol di(meth)acrylate; triglycerol di(meth)acrylate; dipropylene glycol di(meth)acrylate; divinyl ethylene urea; and divinyl propylene urea.

Among these, neopentyl glycol di(meth)acrylate; 1,9-nonanediol di(meth)acrylate; tripropylene glycol di(meth)acrylate; tetraethylene glycol di(meth)acrylate; hydroxypivalate neopentyl glycol di(meth)acrylate; polyethylene glycol di(meth)acrylate; and the like are particularly preferred for use in the present invention.

Examples of polyfunctional polymerizable unsaturated monomers having groups with 3 or more ethylene unsaturated bonds include: ECH denatured glycerol tri(meth)acrylate; EO denatured glycerol tri(meth)acrylate; PO denatured glycerol tri(meth)acrylate; pentaerythritol triacrylate; EO denatured phosphate triacrylate; trimethylol propane tri(meth)acrylate; caprolactone denatured trimethylol propane tri(meth)acrylate; EO denatured trimethylol propane tri(meth)acrylate; PO denatured trimethylol propane tri(meth)acrylate; tris(acryloxyethyl)isocyanylate; dipentaerythritol hexa(meth)acrylate; caprolactone denatured dipentaerythritol hexa(meth)acrylate; dipentaerythritol hydroxy penta(meth)acrylate; alkyl denatured dipentaerythritol penta(meth)acrylate; dipentaerythritol poly(meth)acrylate; alkyl denatured dipentaerythritol tri(meth)acrylate; ditrimethylol propane tetra(meth)acrylate; pentaerythritol ethoxy tetra(meth)acrylate; and pentaerythritol tetra(meth)acrylate.

Among these, EO denatured glycerol tri(meth)acrylate; PO denatured glycerol tri(meth)acrylate; trimethylol propane tri(meth)acrylate; EO denatured trimethylol propane tri(meth)acrylate; PO denatured trimethylol propane tri(meth)acrylate; dipentaerythritol hexa(meth)acrylate; pentaerythritol ethoxy tetra(meth)acrylate; pentaerythritol tetra(meth)acrylate; and the like are favorably employed in the present invention.

From among the polyfunctional polymerizable unsaturated monomers having two or more ethylene unsaturated bonds, it is preferable for polyfunctional (meth)acrylates to be employed from the viewpoint of photocuring properties. Note that here, the expression “polyfunctional (meth)acrylates” as used here collectively refer to the (meth)acrylates having two functions and the (meth)acrylates having three or more functions listed above. Specific examples of the polyfunctional (meth)acrylates include the various polyfunctional (meth)acrylates from among the (meth)acrylates having two functions and the (meth)acrylates having three or more functions listed above.

Examples of compounds having oxirane rings (epoxy compounds) include: hydrogenated compounds, such as polybasic acid polyglycidyl esters, polyhydroxy alcohol polyglycidyl ethers, polyoxyalkylene glycol polyglycidyl ethers, aromatic polyol polyglycidyl ethers, and aromatic polyol polyglycidyl ethers; urethane polyepoxy compounds; and epoxylated polybutadienes. These compounds may be used singly or in combinations of two or more.

Specific examples of the compounds having oxirane rings (epoxy compounds) that can be favorably utilized in the present invention include: polyether polyol polyglycidyl ethers, obtained by adding one or more types of alkylene oxides to an aliphatic polyhydroxy alcohol, such as 1,4-butanediol diglycidyl ether, 1,6-hexanediol diglycidyl ether, glycerin triglycidyl ether, trimethylol propane triglycidyl ether, polyethylene glycol diglycidyl ether, polypropylene glycol diglycidyl ethers, ethylene glycol, propylene glycol, and glycerin; aliphatic long chain dibasic acid diglycidyl esters; aliphatic higher alcohol monoglycidyl ethers; and higher aliphatic acid glycidyl esters.

Among these, 1,4-butanediol diglycidyl ether, 1,6-hexanediol diglycidyl ether, glycerin triglycidyl ether, trimethylol propane triglycidyl ether, neopentyl glycol diglycidyl ether, polyethylene glycol diglycidyl ether, and polypropylene glycol diglycidyl ether are particularly preferred.

Commercially available products that can be favorably utilized as glycidyl containing compounds include: UVR-6216 (by Union Carbide Co.); Glycydol, AOEX24, and Cyclomer A200 (by Daicel Chemical Industries, K.K.); Epicoat 828, Epicoat 812, Epicoat 1031, Epicoat 872, and Epicoat CT508 (by Yuka Shell, K.K.); and KRM-2400, KRM-2410, KRM-2408, KRM-2490, KRM-2720, and KRM-2750 (by Asahi Denka Industries, K.K.). These products may be used either singly or in combinations of two or more.

The methods by which the compounds having oxirane rings are produced are not limited. These compounds may be synthesized by referring to the disclosures of: Y. Ito et al., “20 Organic Syntheses II”, Experimental Chemistry Lessons, pp. 213-225, 1992, Maruzen K.K. Press; A. Hasfner, “The Chemistry of Heterocyclic Compounds: Small Ring Heterocycles Part 3: Oxiranes”, Vol. 42, pp. 1-196, 1985, John Wiley and Sons, An Interscience Publication, New York; Yoshimura, “Adhesives”, Vol. 29, No. 12, pp. 32-38, 1985; Yoshimura, “Adhesives”, Vol. 30, No. 5, pp. 43-46, 1986, Yoshimura, “Adhesives”, Vol. 30, No. 7, pp. 42-46, 1986; Japanese Unexamined Patent Publication No. 11 (1999)-100378; Japanese Patent No. 2906245; and Japanese Patent No. 2926262.

Known vinyl ether compounds may be selected as the vinyl ether compounds. Examples of vinyl ether compounds include: 2-ethylhexyl vinyl ether; butanediol-1,4-divinyl ether; diethylene glycol monovinyl ether; ethylene glycol divinyl ether; triethylene glycol divinyl ether; 1,2-propanediol divinyl ether; 1,3-propanediol divinyl ether; 1,3-butanediol divinyl ether; 1,4-butanediol divinyl ether; 1,4-butanediol vinyl ether; tetramethylene glycol divinyl ether; neopentyl glycol divinyl ether; trimethylol propane trivinyl ether; trimethylol ethane trivinyl ether; hexanediol divinyl ether; tetraethylene glycol divinyl ether; pentaerythritol divinyl ether; pentaerythritol trivinyl ether; pentaerythritol tetravinyl ether; sorbitol tetravinyl ether; sorbitol pentavinyl ether; ethylene glycol diethylene vinyl ether; triethylene glycol diethylene vinyl ether; ethylene glycol dipropylene vinyl ether; triethylene glycol diethylene vinyl ether; trimethylol propane triethylene vinyl ether; trimethylol propane diethylene vinyl ether; pentaerythritol diethylene vinyl ether; pentaerythritol triethylene vinyl ether; pentaerythritol tetraethylene vinyl ether; 1,1,1-tris[4-(2-vinyloxyethoxy)phenyl]ethane; and bisphenol A divinyloxyethyl ether.

These vinyl ether compounds may be synthesized by the method disclosed in S. C. Lapin, Polymers Paint Colour Journal, Vol. 179, No. 4237, p. 321, 1988. That is, the vinyl ether compounds may be synthesized by a reaction between a multivalent alcohol or a multivalent phenol and acetylene, or by a reaction between a multivalent alcohol or a multivalent phenol and halogenated alkyl vinyl ether. The vinyl ether compounds may be used either singly or in combinations of two or more.

### (B: Polymerization Initiating Agent)

In addition, the present invention employs a polymerization initiating agent B having an absorption region at a longer wavelength side than the long wavelength side end wavelength λm of the polymerizable compounds (all of the polymerizable compounds including the one or more types of polymerizable compounds A and the other polymerizable compounds C) as a photopolymerization initiating agent. Further advantageous effects obtained by the present invention are reduction in exposure loss due to spectral absorption by the polymerizable compounds and improved productivity.

The polymerization initiating agent B of the present invention has an absorption region at a longer wavelength side than the absorption spectrum properties of the polymerizable compound of the present invention. Specifically, having an absorption region at a longer wavelength side means that a relationship λb<λC is established when a set wavelength at the longer wavelength side related to the absorption spectrum properties of the polymerizable compound at which the degree of light absorption becomes 10% with respect to a degree of light absorption at a maximum peak is designated as λb and a set wavelength at the longer wavelength side related to the absorption spectrum properties of the polymerization initiating agent at which the degree of light absorption becomes 10% with respect to a degree of light absorption at a maximum peak is designated as λc.

Note that in the present invention, it is preferable for a relationship λb+10<λc to be established, and more preferable for a relationship λb+30<λc to be established.

In the nanoimprinting method of the present invention, it is preferable for the peak wavelength of the absorption spectrum properties of the polymerization initiating agent to be 340 nm or greater. In this case, the polymerization initiating agent can be effectively utilized by performing exposure in a region at a longer wavelength side than that of the spectral spectrum of the polymerizable compound, resulting in improvements in productivity.

Examples of the polymerization initiating agent that can be utilized include: 2-hydroxy-1-[4-(2-hydroxyethoxy) phenyl]-2-methyl-1-propanone (Irgacure 2959 by BASF, for example); 2-benzyl-2-dimethyl amino-1-(4-morphorinophenyl)butanone-1 (Irgacure 369 by BASF, for example); 2-dimethylamino-2-(4 methyl benzyl)-1-(4-morphorine-4-ilphenyl)butane-1-one (Irgacure 379 by BASF, for example); 2-methyl-1{4-methylthiophenyl}-2-morphorinopropane-1-one (Irgacure 907 by BASF, for example); α,α-dimethoxy-α-phenylacetophenone (Irgacure 651 by BASF, for example); phosphine oxide, phenyl bis(2,4,6-trimethylbenzoyl) (Irgacure 819 by BASF, for example); 2-hydroxy-2-methyl-1-phenyl-1-propanone (Irgacure 1173 by BASF, for example); Irgacure 2100; diphenyl (2,4,6-trimethyl benzoyl)-phosphine oxide (Darocure TPO by BASF, for example); bis(eta 5-2,4-cyclopentadiene-1-il)bis[2,6-difuloro-3-(1H-pyrrole-1-il) phenyl]titanium (Irgacure 784 by BASF, for example).

Examples of other preferred polymerization initiating agents include the following. The compound disclosed in Japanese Unexamined Patent Publication No. 2011-080036, the coumalin series pigment disclosed in Japanese Unexamined Patent Publication No. 9 (1997)-003109; a photooxidation generating agent which is one of a halomethyl group substituent-S-triazine derivative and a diphenyl iodonium base compound; a visible light polymerization initiating agent constituted by an aryl borate compound; the α-diketone disclosed in Japanese Unexamined Patent Publication No. 2009-051925; a non polymerizable acidic compound; a photopolymerization initiating agent the includes a carbonyl group substituted aromatic amine; the α-diketone disclosed in Japanese Unexamined Patent Publication No. 2007-131721; a trihalomethyl group substituted-1,3,5-triazine compound; a photopolymerization initiating agent constituted by a (bis) acylphosphineoxide compound; and the visible light polymerization initiating agent constituted by a visible light absorbing cation dye-boron anion chain and a boron series sensitizer disclosed in Japanese Patent No. 2925269.

### (D: Other Components)

The curable composition of the present invention may include other components such as polymerizable compounds including at least one of fluorine atoms and silicon atoms to be described layer, non polymerizable surfactant compounds, antioxidant agents, solvents, polymer components, pigments, and dyes in addition to the polymerizable compounds and the photopolymerization initiating agent described above within a range that does not stray from the scope of the present invention according to various purposes. It is preferable for the curable composition of the present invention to include at least one of a surfactant and an antioxidant agent.

### (D1: Polymerizable Compound Including at Least One of Fluorine Atoms and Silicon Atoms)

It is preferable for the composition of the present invention to include a polymerizable compound D1 that includes at least one of fluorine atoms and silicon atoms as a polymerizable compound. Examples of such compounds will be described below.

### (D1-1: Polymerizable Compound Including at Least One of Fluorine Atoms and Silicon Atoms for Improving Mold Release Properties)

In the present invention, a polymerizable compound that include at least one of fluorine atoms and silicon atoms as polymerizable compounds may be added in order to improve mold release properties. Favorable mold release properties can be obtained without employing a surfactant if such a compound is added.

The polymerizable compound D1 has at least one group having a fluorine atom, a silicon atom, or both a fluorine atom and a silicon atom, and at least one polymerizable functional group. Preferred examples of the polymerizable functional group include: methacryloyl groups; epoxy groups; and vinyl ether groups.

The polymerizable compound D1 may be a low molecular compound or a polymer.

In the case that the polymerizable compound D1 is a polymer, the polymer may have repetitive units having at least one of the fluorine atoms and the silicon atoms, and repetitive units having polymerizable groups on the side chains thereof as copolymer components. Alternatively, the repetitive units having at least one of the fluorine atoms and the silicon atoms may have polymerizable groups on the side chains, and particularly on the ends thereof. In this case, the framework of the repetitive units having at least one of the fluorine atoms and the silicon atoms is not particularly limited as long as it does not stray from the scope of the present invention. However, it is preferable for the repetitive units to have a framework derived from groups having ethylene unsaturated bonds, and more preferably a (meth)acrylate framework. In addition, the repetitive units having the silicon atoms may be those in which the silicon atoms themselves form the repetitive units, such as in a siloxane structure (a dimethyl siloxane structure, for example). It is preferable for the weight average molecular weight of the polymerizable compound D1 to be within a range from 2000 to 100000, more preferably within a range from 3000 to 70000, and most preferably within a range from 5000 to 40000.

### (D1-2: Polymerizable Compound Having Fluorine Atoms)

Fluorine containing groups selected from fluoroalkyl groups and fluoroalkyl ether groups are preferable as groups having fluorine atoms in the polymerizable compound D1-2 having fluorine atoms.

Fluoroalkyl groups having a carbon number within a range from 2 to 20 are preferred as fluoroalkyl groups. Fluoroalkyl groups having a carbon number within a range from 4 to 8 are most preferable. Examples of such preferable fluoroalkyl groups include: trifluoromethyl groups, pentafluoroethyl groups, heptafluoropropyl groups, hexafluoroisopropyl groups, nonafluorobutyl groups, tridecafluorohexyl groups, and heptadecafluorooctyl groups.

In the present invention, it is preferable for the polymerizable compound D1-2 to be a polymerizable compound having a trifluoromethyl group structure with a fluorine atom. By adopting the trifluoromethyl group structure, the advantageous effects of the present invention will be exhibited with a small amount (10% by mass or less) of the polymerizable compound D1-2. Therefore, the compatibility with other components will improve, the line edge roughness after dry etching will improve, and repeated pattern formability will improve.

It is preferable for the fluoroalkyl ether groups to have a trifluoromethyl group in the same manner as the fluoroalkyl groups. Fluoroalkyl ether groups having perfluoroethylene oxy groups or perfluoropropylene oxy groups are preferred. Fluoroalkyl ether units having trifluoromethyl groups such as —(CF(CF₃)CF₂O)— and/or fluoroalkyl ether groups having trifluoromethyl groups at the ends thereof are preferred.

It is preferable for the total number of fluorine atoms in the fluorine containing polymerizable compound to be within a range from 6 to 60 per molecule, more preferably within a range from 9 to 40 per molecule, still more preferably within a range from 12 to 40 per molecule, and most preferably within a range from 12 to 20 per molecule.

It is preferable for the polymerizable compound D1-2 to be a polymerizable compound having fluorine atoms in which the fluorine content defined below is within a range from 20% to 60%. It is preferable for the fluorine content of the polymerizable compound D1-2 to be within a range from 20% to 60%, and more preferably within a range from 35% to 60%. In the case that the polymerizable compound D1-2 is constituted by polymers having polymerizable groups, it is preferable for the fluorine content to be within a range from 20% to 50%, and more preferably within a range from 20% to 40%. By setting the fluorine content to be in an appropriate range, superior compatibility with other components will be achieved, contamination of the mold can be reduced, and line edge roughness following dry etching will be improved. As a result, repeated pattern formability will be improved. In the present specification, the fluorine content is represented by Formula 3 below:

$$FluorineContent = \frac{\begin{matrix}( FluorineAtomsInPolynerizableCompound ) \times \\ ( AtomicWeightOfFluorine )\end{matrix}}{MolecularWeight of PolymerizableCompound} \times 100 \qquad Formula 3$$

An example of a preferred polymerizable compound D1-2 is a compound (monomer) having a group with a fluorine atom, having a partial structure represented by General Formula III below. By employing a compound having such a partial structure, pattern formability will remain superior even if pattern transfer is repeatedly performed, and the stability of the composition over time will be favorable.

—CH₂CH₂—CₙF₂ₙ₊₁ General Formula III

In General Formula III, n represents an integer from 1 to 8, and preferably an integer from 4 to 6.

Another example of a preferred polymerizable compound D1-2 is a compound having a partial structure represented by General Formula IV below. The compound may have both the partial structure represented by General Formula III and the partial structure represented by General Formula IV.

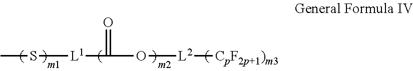

In General Formula (IV), L¹ represents a single bond or an alkylene group having a carbon number from 1 to 8, L² represents an alkylene group having a carbon number from 1 to 8, m1 and m2 respectively represent 0 or 1, wherein at least one of m1 and m2 is 1. m3 represents an integer from 1 to 3, p represents an integer from 1 to 8 and —CₚF₂ₚ₊1 may be the same or different when m3 is 2 or greater.

It is preferable for both L¹ and L² to be an alkylene group having a carbon number from 1 to 4. In addition, the alkylene groups may have substituent groups within a range that does not stray from the scope of the present invention. m3 is preferably 1 or 2. It is preferable for p to be an integer within a range from 4 to 6.

Specific examples of the polymerizable compounds to be employed as the polymerizable compound D1-2 will be indicated below. However, the present invention is not limited to these specific examples.

Examples of compounds to be employed as the polymerizable compound D1-2 include: trifluoroethyl (meth)acrylate; pentafluoroethyl (meth)acrylate; (perfluorobutyl)ethyl (meth)acrylate; perfluorobutyl-hydroxypropyl(meth)acrylate; (perfluorohexyl)ethyl (meth)acrylate; octafluoropentyl(meth)acrylate; perfluorooctylethyl(meth)acrylate; tetrafluoropropyl(meth)acrylate; and hexafluoropropyl(meth)acrylate, which are monofunctional polymerizable compounds having fluorine atoms. Preferred examples of polymerizable compounds having fluorine atoms include polyfunctional polymerizable compounds having two or more polymerizable functional groups, such as: 2,2,3,3,4,4,-hexafluoropentane di(meth)acrylate; 2,2,3,3,4,4,5,5,-octafluorohexane di(meth)acrylate.

In addition, compounds having two or more fluorine containing groups, such as fluoroalkyl groups and fluoroalkyl ether groups per molecule, can also be favorably employed.

Polymerizable compounds represented by General Formula V below are preferable as compounds having two or more fluoroalkyl groups and fluoroalkyl ether groups per molecule.

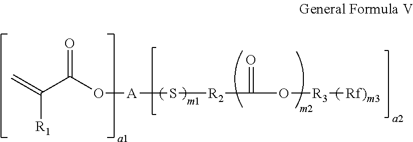

In General Formula V, R¹ represents a hydrogen atom, an alkyl group, a halogen atom, or a cyano group. It is preferable for R¹ to be a hydrogen atom or an alkyl group, more preferable for R¹ to be a hydrogen atom or a methyl group, and most preferable for R¹ to be a hydrogen atom.

A represents a linking group having a valence of (a1+a2). It is preferable for A to be a linking group having an alkylene group and/or an arylene group, and may further include a linking group that has a hetero atom. Examples of linking groups having hetero atoms include: —O—; —C(═O)O—; —S—; and —C(═O)—. These groups may have substituent groups within a range that does not stray from the scope of the present invention, but it is preferable for these groups to not have substituent groups. It is preferable for the carbon number of A to be within a range from 2 to 15, and more preferably within a range from 4 to 15.

a1 represents an integer from 1 to 6. a1 is preferably 1 to 3, and more preferably 1 or 2.

a2 represents an integer from 2 to 6. a2 is preferably 2 or 3, and more preferably 2.

R₂ and R₃ respectively represent an alkylene group having a carbon number from 1 to 8. m1 and m2 respectively represent 0 or 1, and m3 represents an integer from 1 to 3.

When a1 is 2 or greater each R₁ may be the same or different.

When a2 is 2 or greater, each R₂, R₃, m1, m2, and m3 may be the same or different.

When m3 is 2 or greater, each Rf may be the same or different.

Rf represents a fluoroalkyl group or a fluoroalkyl ether group. Rf preferably represents a fluoroalkyl group having a carbon number within a range from 1 to 8 or a fluoroalkyl ether group having a carbon number within a range from 3 to 20.

In the case that the polymerizable compound D1-2 is a polymer, it is preferable for the polymer includes the polymerizable compound D1-2 as repeating units.

The amount of the above compound to be included in the curable composition for imprinting is not particularly limited. However, it is preferable for the amount of the compound in the curable composition to be within a range from 0.1% by mass to 20% by mass, more preferably within a range from 0.2% by mass to 15% by mass, still more preferably within a range from 0.5% by mass to 10% by mass, and most preferably within a range from 0.5% by mass to 5% by mass, from the viewpoints of improving the curing properties and decreasing the viscosity of the composition.

Specific examples of the polymerizable monomers to be employed as the polymerizable compound D1-2 will be indicated below. However, the present invention is not limited to these specific examples. R¹ in the following formulae are one of a hydrogen atom, an alkyl group, a halogen atom, and a cyano group, respectively.

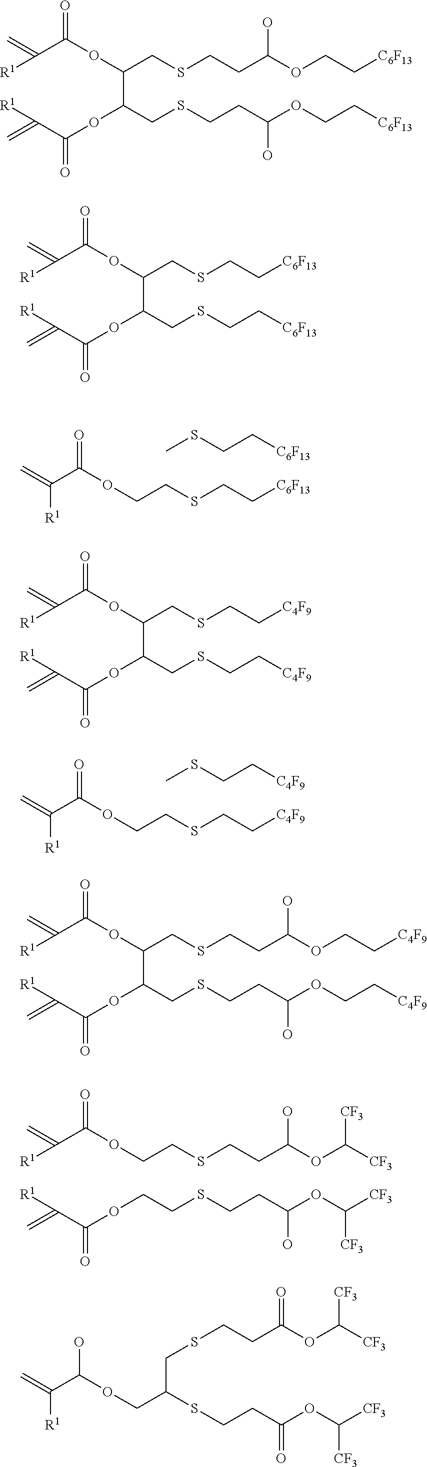

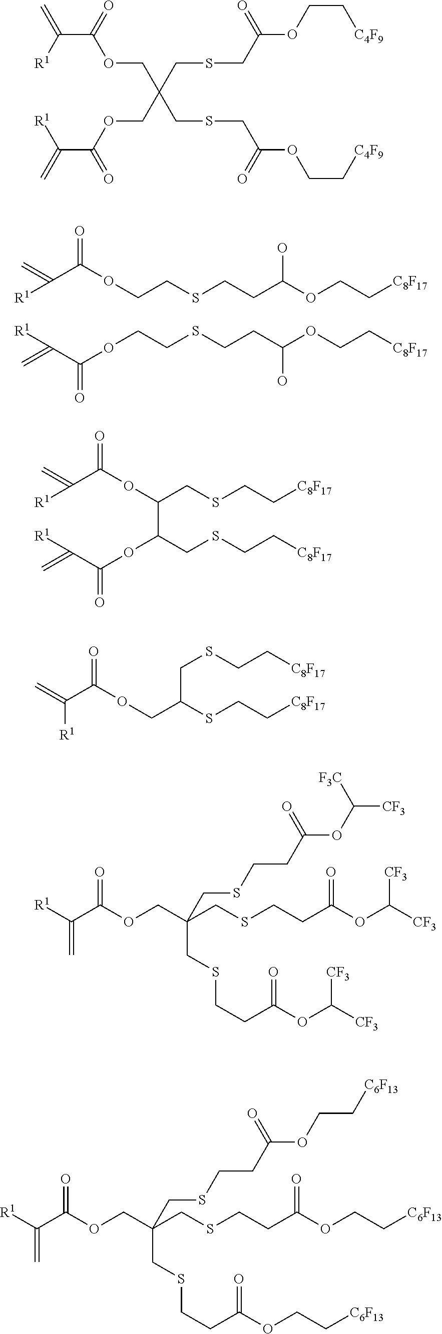

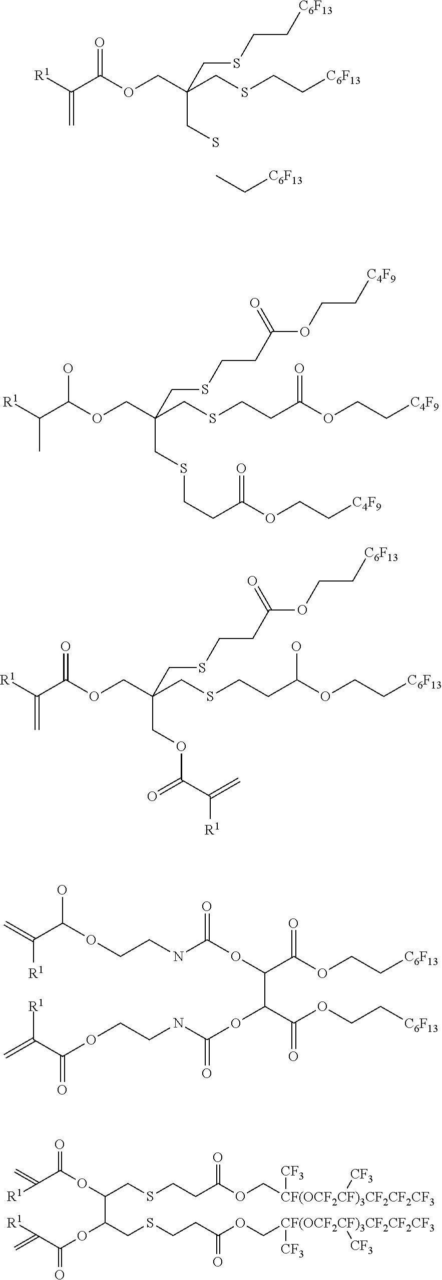

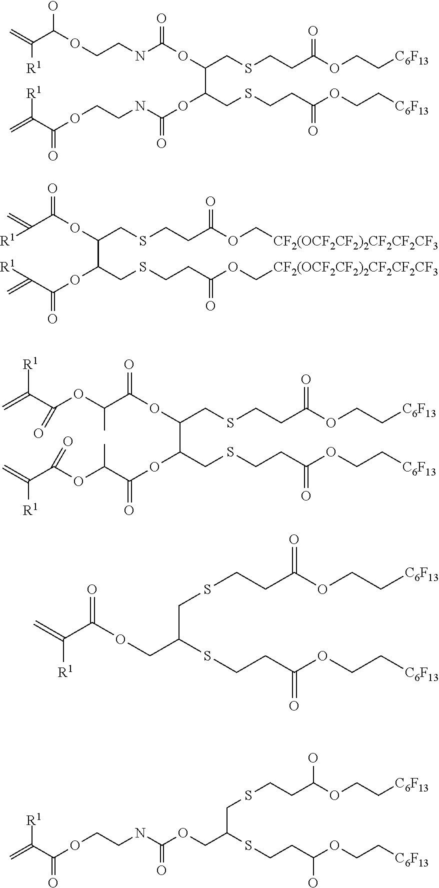

### (D1-3: Polymerizable Compound Having Silicon Atoms)

Examples of functional groups that have silicon atoms of the polymerizable compound D1-3 having silicon atoms include: trialkylsilyl groups; chained siloxane structures, ring shaped siloxane structures, and cubic siloxane structures. It is preferable for the functional groups to be trimethylsilyl groups or those having a dimethyl siloxane structure, from the viewpoints of compatibility with other components and mold release properties.

Examples of the polymerizable compound D1-3 include: 3-tris(trimethylsilyloxy)silylpropyl(meth)acrylate; trimethylsilylethyl (meth)acrylate; (meth)acryloxymethyl bis(trimethylsiloxy)methyl silane; (meth)acryloxymethyl tris(trimethylsiloxy)methyl silane; 3-(meth)acryloxypropyl bis(trimethylsiloxy)methyl silane; and polysiloxanes having (meth)acryloyl groups at the ends or on the side chains (X-22-164 series, X-22-174DX, X-22-2426, and X-22-2475 by Shinetsu Chemical Industries, for example).

### (D2: Non Polymerizable Compound)

Further, the composition of the present invention may also include a non polymerizable compound D2 having at least one hydroxy group at the ends thereof or a polyalkylene glycol structure in which a hydroxy group is etherified, which practically does not include fluorine atoms or silicon atoms.

Here, the non polymerizable compound refers to a compound that does not have polymerizable groups.

Preferred examples of the polyalkylene glycol structure of the non polymerizable compound D2 employed in the present invention include: a polyalkylene glycol structure including an alkylene group having a carbon number within a range from 1 to 6; a polyethylene glycol structure; a polypropylene glycol structure; and a polybutyrene glycol structure, more preferably mixed structures thereof. The polyethylene glycol structure, the polypropylene glycol structure, and mixed structures thereof are still more preferable, and the polypropylene glycol structure is most preferable.

Further, it is preferable for the non polymerizable compound D2 to be practically constituted only by polyalkylene glycol structures excluding substituent groups at the ends thereof. Here, the expression “practically” means that constituent elements other than the polyalkylene glycol structures constitute 5% by mass or less, and more preferably 1% by mass or less of the non polymerizable compound D2. In the present invention, it is particularly preferable for a compound practically constituted only by polyalkylene glycol structures to be included in the non polymerizable compound D2.

It is preferable for the polyalkylene glycol structure to have 3 to 1000 alkylene glycol constituent units, more preferably 4 to 500 alkylene glycol constituent units, still more preferably 5 to 100 alkylene glycol constituent units, and most preferably 5 to 50 alkylene glycol constituent units.

It is preferable for the weight average molecular weight (Mw) of the non polymerizable compound D2 to be within a range from 150 to 10000, more preferably within a range from 200 to 5000, still more preferably within a range from 500 to 4000, and most preferably within a range from 600 to 3000.

That the non polymerizable compound D2 practically does not include fluorine atoms or silicon atoms means that the total content of fluorine atoms and silicon atoms is 1% or less, and more preferably that the non polymerizable compound D2 does not include any fluorine atoms or silicon atoms. Compatibility with the other polymerizable compounds will improve by the non polymerizable compound D2 not including fluorine atoms or silicon atoms. As a result, coating uniformity, pattern formability, and line edge roughness following dry etching will become favorable, particularly in a composition that does not include a solvent.

The non polymerizable compound D2 has at least one hydroxy group at the ends thereof or an etherified hydroxy group. If the non polymerizable compound D2 has at least one hydroxy group at the ends thereof or an etherified hydroxy group, the remaining ends may have hydroxy groups or hydroxy groups in which the hydrogen atom is substituted. Alkyl groups (that is, polyalkylene glycol alkyl ether) and acyl groups (that is, polyalkylene glycol ester) are preferred groups in which the hydrogen atom of a hydroxy group at the end can be substituted. Polyalkylene glycol, in which all of the ends are hydroxy groups, is particularly preferable. A compound having a plurality (preferably 2 or 3) of polyalkylene glycol chains via linking groups may also be favorably employed. However, compounds having straight polyalkylene glycol chains without any branching are more preferable. Diol type polyalkylene glycols are particularly preferable.

Specific preferred examples of the non polymerizable compound D2 include: polyethylene glycol; polypropylene glycol; mono or dimethyl ethers thereof; mono or dioctyl ethers thereof, mono or diononyl ethers thereof; mono or dideccyl ethers thereof; monostearic acid ester; monooleic acid ester; monoadipic acid ester; and monosuccinic acid ester.

It is preferable for the amount of the non polymerizable compound D2 to be included in the resist composition of the present invention to be within a range from 0.1% by mass to 20% by mass, more preferably within a range from 0.2% by mass to 10% by mass, still more preferably within a range from 0.5% by mass to 5% by mass, and most preferably within a range from 0.5% by mass to 3% by mass of the composition excluding solvent.

### (D3: Surfactant)

The curable composition of the present invention may include a surfactant. However, the compound having fluorine atoms and/or silicon atoms are added as the polymerizable compound A in the present invention. Therefore, the composition can be prepared practically without including a surfactant (including a surfactant at less than 0.001% by mass of the composition, for example). It is preferable for the curable composition of the present invention to include a compound having fluorine atoms and/or silicon atoms as the polymerizable compound A or to include a surfactant having fluorine atoms and/or silicon atoms. The amount of surfactant to be included in the photocuring composition of the present invention is within a range from 0.001% to 5% by mass, preferably within a range from 0.002% to 4% by mass, and most preferably within a range from 0.005% to 3% by mass. In the case that two or more types of surfactants are to be included, the combined amount thereof should fall within the above ranges. If the amount of surfactant included in the composition is within a range from 0.001% to 5% by mass, coating uniformity is favorable, and deterioration of mold transfer properties due to excessive amounts of surfactant become less likely to occur.

It is preferable for the surfactant to be a non ionic surfactant, and to include at least one of fluorine series surfactants, silicon series surfactants, and fluorine/silicone series surfactants. Note that non ionic surfactants are preferred as the fluorine series surfactant and the silicone series surfactant.

Here, the “fluorine/silicone series surfactants” refer to surfactants that satisfy the requirements of both fluorine series surfactants and silicone series surfactants.

By employing the surfactants such as those described above, it becomes possible to resolve problems associated with coating failure, such as striations and scale like patterns (uneven drying of resist film) that occur when the curable composition for nanoimprinting is coated onto silicon wafers for producing semiconductor elements, rectangular glass substrates for producing liquid crystal elements, and substrates on which various layers such as chrome films, molybdenum films, molybdenum alloy films, tantalum films, tantalum alloy films, silicon nitride films, amorphous silicone films, ITO (Indium Tin Oxide, in which tin oxide is dope into indium oxide) are formed. In addition, the fluidity of the composition of the present invention with respect to the interiors of the cavities of the recesses of the mold, the release properties between the mold and the composition, and close contact properties between the composition and the substrate are improved. In addition, it becomes possible to decrease the viscosity of the composition. Particularly, the coating uniformity of the curable composition for nanoimprinting of the present invention can be greatly improved by adding the surfactant. Thereby, favorable coating properties can be obtained regardless of the size of the substrate during coating using a spin coater or a slit scan coater.

Examples of non ionic fluorine series surfactants that can be employed in the present invention include: Fluorad FC-430 and Fluorad FC-431 (by Sumitomo 3M, K.K.); Surflon S-382 (by Asahi Glass Chemical, K.K.); EFTOPEF-122A, 122B, 122C, EF-121, EF-126, EF-127, and MF-100 (by K.K. Tochem Products); PF-636, PF-6320, PF-656, and PF-6520 (by OMNOVA Solutions, Inc.); Ftergent FT250, FT251, and DFX18 (by K.K. Neos); Unidyne DS-401, DS-403, DS-451 (By Daikin Industries, K.K.); and Megaface 171, 172, 173, 178K, and 178A (by Dainippon Ink Chemical Industries, K.K.).

Examples of non ionic silicone series surfactants include: SI-10 Series (by Takemoto Oil and Fat, K.K.); Megaface Peintad 31 (by Dainippon Ink Chemical Industries, K.K.); and KP-341 (by Shinetsu Chemical Industries, K.K.).

In addition, examples of the fluorine/silicone series surfactants include: X-70-090, X-70-091, X-70-092, and X-70-093 (by Shinetsu Chemical Industries, K.K.); and Megaface R-08 and XRB-4 (by Dainippon Ink Chemical Industries, K.K.).

### (D4: Antioxidant Agent)

It is preferable for the curable composition of the present invention to include a known antioxidant agent. The amount of the antioxidant agent to be included is within a range from 0.01% to 10% by mass, for example, and preferably a range from 0.2% to 5% by mass with respect to the polymerizable compounds. In the case that two or more types of antioxidant agents are employed, the combined amount thereof should fall within the above ranges.

The antioxidant agent suppresses color degradation due to heat and light irradiation, as well as color degradation due to various acidic gases such as ozone, activated oxygen, NOₓ, and SOₓ (x is an integer). Particularly in the present invention, addition of the antioxidant agent results in advantages such as coloration of the cured film being prevented, and decreases in film thickness due to decomposition being reduced. Examples of the antioxidant agent include: hydrazides; hindered amine series antioxidant agents; nitrogen containing heterocyclic ring mercapto series compounds; thioether series antioxidant agents; hindered phenol series antioxidant agents, ascorbic acids; zinc sulfate; thiocyanates; thiourea derivatives; sugars; nitrites; thiosulfonates; and hydroxylamine derivatives. Among these, hindered phenol series antioxidant agents and thioether series antioxidant agents are preferred from the viewpoints of coloration of the cured film and decreased film thickness.

Commercially available antioxidant agents include: Irganox 1010, 1035, 1076, and 1222 (by Ciba Geigy, K.K.); Antigene P, 3C, FR, Sumilizer 5, and Sumilizer GA80 (by Sumitomo Chemical Industries, K.K.); and ADK STAB AO70, AO80, and AO503 (by K.K. ADEKA). The antioxidant agents may be used singly or in combination.

### (D5: Polymerization Preventing Agent)

It is preferable for the curable composition of the present invention to include a small amount of a polymerization preventing agent. It is preferable for the amount of the polymerization preventing agent included in the curable composition of the present invention to be 0.001% to 1% by mass with respect to the total mass of the polymerizable monomers, more preferably within a range from 0.005% to 0.5% by mass, and most preferably within a range from 0.008% to 0.05% by mass. High curing sensitivity can be maintained while suppressing changes in viscosity over time, by incorporating an appropriate amount of the polymerization preventing agent. The polymerization preventing agent may be included in the polymerizable compounds to be employed in advance, or further added to the composition.

Preferred examples of the polymerization preventing agent to be employed in the present invention include: hydroquinone; p-methoxy phenol; di-tert-butyl-p-cresol; pyrogallol; tert-butyl catechol; benzoquinone; 4,4′-thiobis(3-methyl-6-tert-butyl phenol); 2,2′-methylene bis(4-methyl-6-tert-butyl phenol); N-nitrosophenyl hydroxy amine first cerium base; phenothiazine; phenoxadine; 4-methoxy naphthol; 2,2,6,6-tetramethyl piperidine-1-oxyl free radical; 2,2,6,6-tetramethyl piperidine; 4-hydroxy-2,2,6,6-tetramethyl piperidine-1-oxyl free radical; nitrobenzene; and dimethyl arylene. Phenothiazine, 4-methoxy naphthol; 2,2,6,6-tetramethyl piperidine-1-oxyl free radical; 2,2,6,6-tetramethyl piperidine; and 4-hydroxy-2,2,6,6-tetramethyl piperidine-1-oxylr free radical, which have significant effects without the presence of oxygen, are particularly preferable.

### (D6: Solvent)

The curable composition of the present invention may also include various solvents as necessary. Preferred solvents are those having boiling points within a range from 80° C. to 200° C. at atmospheric pressure. Any solvent may be employed as long as it is capable of dissolving the composition. However, preferred solvents are those that include at least one of an ester structure, a ketone structure, hydroxy groups, and an ether structure. Specific examples of such preferred solvents include: propylene glycol monomethyl ether acetate; cyclohexanone; 2-heptanone; gammabutylolactone; propylene glycol monomethyl ether; and ethyl lactate. These solvents may be employed singly or in combinations as mixtures. Solvents that contain propylene glycol monomethyl ether acetate are most preferred from the viewpoint of coating uniformity.

The amount of the solvent to be included in the curable composition of the present invention is optimally adjusted according to the viscosity of the components other than the solvent, the coating properties, and a target film thickness. From the viewpoint of coating properties, however, the solvent may be added at 99% by mass or less with respect to the composition. In the case that the composition of the present invention is to be applied onto substrates by the ink jet method, the solvent is practically not included in the composition (3% by mass or less, and more preferably 1% by mass or less, for example). Meanwhile, in the case that a pattern having a film thickness of 500 nm or less is to be formed by the spin coat method or the like, it is preferable for the amount of the solvent to be within a range from 20% to 99% by mass, more preferably within a range from 40% to 99% by mass, and most preferably within a range from 70% to 98% by mass. The advantageous effects of the present invention are more significantly exhibited in the case that the curable composition that does not include solvent is applied to a substrate by the ink get method, and pattern transfer is executed thereafter.

### (D7: Polymer Components)

The curable composition of the present invention may include polyfunctional oligomers having greater molecular weights than the other polyfunctional polymerizable monomers within a range that enables the objectives of the present invention to be achieved, in order to further increase cross linking density. Examples of polyfunctional oligomers having photoradical polymerization properties are acrylate oligomers, such as: polyester acrylate; urethane acrylate; polyether acrylate; and epoxy acrylate. It is preferable for the amount of oligomer components to be added to be within a range from 0% to 30% by mass with respect to the components of the composition excluding the solvent, more preferably within a range from 0% to 20% by mass, still more preferably within a range from 0% to 10% by mass, and most preferably within a range from 0% to 5% by mass.

The curable composition of the present invention may further include polymer components, from the viewpoints of improving dry etching resistance, imprinting properties, and curing properties. Polymers having polymerizable functional groups at the side chains thereof are preferred as the polymer components. From the viewpoint of compatibility with the polymerizable compound, it is preferable for the weight average molecular weight of the polymer components to be within a range from 2000 to 100000, and more preferably within a range from 5000 to 50000. It is preferable for the amount of the polymer components to be added to be within a range from 0% to 30% by mass with respect to the components of the composition excluding the solvent, more preferably within a range from 0% to 20% by mass, still more preferably within a range from 0% to 10% by mass, and most preferably 2% by mass or less. It is preferable for the amount of polymer components having molecular weights of 2000 or greater to be 30% by mass or less with respect to components of the curable composition of the present invention excluding the solvent, from the viewpoint of pattern formation properties. In addition, it is preferable for resin components to be minimized from the viewpoint of pattern formation properties. It is preferable for resin components to not be included, excluding surfactants and a fine amount of additives.

In addition to the aforementioned components, the curable composition of the present invention may further include: a mold release agent; a silane coupling agent; an ultraviolet ray absorbing agent; a light stabilizing agent; an aging preventing agent; a plasticizing agent; a close contact promoting agent; a thermal polymerization initiating agent; a coloring agent; elastomer particles; a photooxidation proliferating agent; a photobase generating agent; a basic compound; a fluidity adjusting agent; a defoaming agent; and a dispersing agent as necessary.

The curable composition of the present invention can be prepared by mixing each of the aforementioned components. In addition, the curable composition of the present invention can be prepared as a solution, by performing filtering through a filter having a mesh size within a range from 0.003 μm to 5.0 μm after mixing the components. Mixing and dissolving of the photoimprinting curable composition is generally performed within a temperature range from 0° C. to 100° C. The filtering may be performed in a plurality of steps, or repeated a plurality of times. In addition, the filtered liquid may be filtered again. The material of the filter which is utilized in the filtering operation is not particularly limited. Examples of the material of the filter include: polyethylene resin; polypropylene resin; fluorine resin; and nylon resin.

It is preferable for the viscosity of the components of the curable composition of the present invention excluding the solvent to be 100 mPa·s or less, more preferably within a range from 1 to 70 mPa·s, still more preferably within a range from 2 to 50 mPa·s, and most preferably within a range from 3 to 30 mPa·s.

### (Exposure System)

The exposure system of the present invention irradiates light having intensity spectrum properties that satisfy Formula 1 above. The exposure system is not particularly limited. For example, a light source may be utilized that has intensity spectrum properties only within a specific wavelength range greater than or equal to a desired wavelength, or a light source having wide bandwidth spectral properties (a high pressure mercury lamp, a metal halide lamp, or a xenon lamp, for example) and an optical element such as a cutoff filter may be combined, to cause light having predetermined intensity spectrum properties to be emitted.

As described previously, the exposure system is selected such that the intensity spectrum properties thereof do not overlap with the absorption spectrum properties of the polymerizable compound (including the absorption spectrum properties of the other polymerizable compounds C with absorption regions within a range from 250 nm to 500 nm) as much as possible. Therefore, it is preferable for the set light emission wavelength to be 340 nm or greater in the present invention. In addition, it is preferable for the exposure system that executes exposure to be equipped with an LED (Light Emitting Diode) light source, and for the peak wavelength of the intensity spectrum properties to be 350 nm or greater. It is also preferable for the exposure system to be equipped with a sharp cut filter having a transmissivity of 1% or less, at least with respect to light having a wavelength of 300 nm. Alternatively, it is preferable for the exposure system to be equipped with a sharp cut filter having a transmissivity of 1% or less, at least with respect to light having a wavelength of 340 nm.

### (Operational Effects)

In conventional known techniques, deterioration of materials resulted in decomposed materials to adhere and accumulate onto the surfaces of molds, resulting in contamination of the molds. This caused separating force when separating molds from substrates to increase. In addition, in the case that exposure times were shortened, exposure inhibition due to the absorption properties of polymerizable compounds resulted in insufficient initiating reactions by polymerization initiating agents. This caused insufficient curing and generated increased mold release defects. Accordingly, conventional methods cannot sufficiently fill the demand for shortened exposure times and shortened mold release times in order to improve productivity.

Further, from the viewpoint of durability, with respect to demand to perform nanoimprinting by repeatedly utilizing a single mold, conventional techniques result in accumulated mold contamination that cause mold release to be difficult. In addition, if contamination of the mold progresses, pattern formation becomes difficult, and the durability of the mold will become insufficient.

In the present invention, the longer wavelength end wavelength of the absorption region of the polymerizable compound and the longer wavelength end wavelength of the absorption region of the polymerization initiating agent are configured as described above. Therefore, absorption of the light during exposure by the polymerization initiating agent is facilitated. That is, in the present invention, the intensity spectrum properties of the light emitted by the exposure system and the absorption spectrum properties of the polymerizable compound of the resist are sufficiently separated. Therefore, deterioration of materials due to exposure by the photocuring exposure system can be prevented. Accordingly, productivity of nanoimprinting operations and durability of molds can both be improved.

### EXAMPLES

Examples of the nanoimprinting method of the present invention will be described below.

[Investigations Regarding Appropriate Combinations of Polymerizable Compounds and Polymerization Initiating Agents]

First, appropriate combinations of polymerizable compounds and polymerization initiating agents will be considered.

### <Resist Compositions Formulating Step>

6 resist compositions were prepared according to the 6 formulations below. Note that the polymerizable compounds A through E and M220 are compounds having the structures illustrated in Table 1.

TABLE 1

| | Ohnishi | Ring | Ch |
|---|---|---|---|
| Structural Formula of Monomer | P | P | Formula |
| 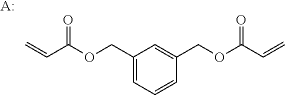 | 3.2 | 0.43 | C₁₄H₁₄O₄ |
| 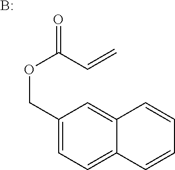 | 2.33 | 0.71 | C₁₄H₁₂O₂ |
| 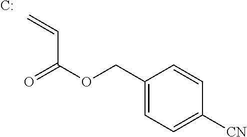 | 2.56 | 0.55 | C₁₁H₉O₂N |
| 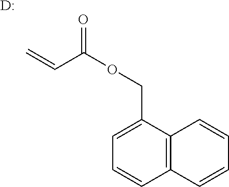 | 2.33 | 0.71 | C₁₄H₁₂O₂ |
| 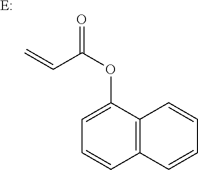 | 2.27 | 0.77 | C₁₃H₁₀O₂ |
| M220: | 5 | 0 | C₁₆H₂₄O₆ |
| CH₂═CHCO—(OC₃H₆)₃—OCOCH═CH₂ | | | |
| M310: | 3.78 | 0 | C₂₄H₃₈O₆ |
| [CH₂═CHCO—(OC₃H₆) CH₂]₃—CCH₂CH₃ | | | |

### (Formulation 1-1)

Monomer A of Table 1 was employed as a polymerizable compound, Irgacure™ 379 (by BASF Japan) was employed as a polymerization initiating agent, and PF3320 (by OMNOVA) was employed as an additive. Monomer A, Irgacure™ 379, and PF3320 were mixed at a ratio of 100:2:2, to prepare a resist composition.

The absorption spectrum properties of the resist composition prepared according to formulation 1-1 were measured. As a result, the longer wavelength end wavelength λm of the polymerizable compound was 252 nm, the longer wavelength end wavelength λi of the polymerization initiating agent was 381.5 nm, the set absorption wavelength λb of the polymerizable compound was 276 nm, and the set absorption wavelength λc of the polymerization initiating agent was 360 nm. In addition, the Ohnishi parameter of the resist composition was 3.2, and the ring parameter of the resist composition was 0.43.

### (Formulation 1-2)

Monomer B and M220 of Table 1 were employed as polymerizable compounds, Irgacure™ 379 (by BASF Japan) was employed as a polymerization initiating agent, and PF3320 (by OMNOVA) was employed as an additive. Monomer B, M220, Irgacure™ 379, and PF3320 were mixed at a ratio of 80:20:2:2, to prepare a resist composition.

The absorption spectrum properties of the resist composition prepared according to formulation 1-2 were measured. As a result, the longer wavelength end wavelength λm of the polymerizable compound was 305 nm, the longer wavelength end wavelength λi of the polymerization initiating agent was 381.5 nm, the set absorption wavelength λb of the polymerizable compound was 295 nm, and the set absorption wavelength λc of the polymerization initiating agent was 360 nm. In addition, the Ohnishi parameter of the resist composition was 2.864, and the ring parameter of the resist composition was 0.568. Note that in cases that the polymerizable compound is constituted by a plurality of compounds, weighted average values of the Ohnishi parameter and the ring parameter thereof are designated as the Ohnishi parameter and the ring parameter.

### (Formulation 1-3)

Monomer C and M220 of Table 1 were employed as polymerizable compounds, Irgacure™ 379 (by BASF Japan) was employed as a polymerization initiating agent, and PF3320 (by OMNOVA) was employed as an additive. Monomer C, M220, Irgacure™ 379, and PF3320 were mixed at a ratio of 80:20:2:2, to prepare a resist composition.

The absorption spectrum properties of the resist composition prepared according to formulation 1-3 were measured. As a result, the longer wavelength end wavelength λm of the polymerizable compound was 282.5 nm, the longer wavelength end wavelength λi of the polymerization initiating agent was 381.5 nm, the set absorption wavelength λb of the polymerizable compound was 285 nm, and the set absorption wavelength λc of the polymerization initiating agent was 360 nm. In addition, the Ohnishi parameter of the resist composition was 3.048, and the ring parameter of the resist composition was 0.44.

### (Formulation 1-4)

Monomer D and M220 of Table 1 were employed as polymerizable compounds, Irgacure™ 379 (by BASF Japan) was employed as a polymerization initiating agent, and PF3320 (by OMNOVA) was employed as an additive. Monomer D, M220, Irgacure™ 379, and PF3320 were mixed at a ratio of 80:20:2:2, to prepare a resist composition.

The absorption spectrum properties of the resist composition prepared according to formulation 1-4 were measured. As a result, the longer wavelength end wavelength λm of the polymerizable compound was 314 nm, the longer wavelength end wavelength λi of the polymerization initiating agent was 381.5 nm, the set absorption wavelength λb of the polymerizable compound was 300 nm, and the set absorption wavelength λc of the polymerization initiating agent was 360 nm. In addition, the Ohnishi parameter of the resist composition was 2.864, and the ring parameter of the resist composition was 0.568.

### (Formulation 1-5)

Monomer E and M220 of Table 1 were employed as polymerizable compounds, Irgacure™ 379 (by BASF Japan) was employed as a polymerization initiating agent, and PF3320 (by OMNOVA) was employed as an additive. Monomer E, M220, Irgacure™ 379, and PF3320 were mixed at a ratio of 80:20:2:2, to prepare a resist composition.

The absorption spectrum properties of the resist composition prepared according to formulation 1-5 were measured. As a result, the longer wavelength end wavelength λm of the polymerizable compound was 319.5 nm, the longer wavelength end wavelength λi of the polymerization initiating agent was 381.5 nm, the set absorption wavelength λb of the polymerizable compound was 310 nm, and the set absorption wavelength λc of the polymerization initiating agent was 360 nm. In addition, the Ohnishi parameter of the resist composition was 2.816, and the ring parameter of the resist composition was 0.616.

### (Formulation 1-6)

Monomer A and Monomer B of Table 1 were employed as polymerizable compounds, Irgacure™ 379 (by BASF Japan) was employed as a polymerization initiating agent, and PF3320 (by OMNOVA) was employed as an additive. Monomer A, Monomer B, Irgacure™ 379, and PF3320 were mixed at a ratio of 50:50:2:2, to prepare a resist composition.

The absorption spectrum properties of the resist composition prepared according to formulation 1-6 were measured. As a result, the longer wavelength end wavelength λm of the polymerizable compound was 305 nm, the longer wavelength end wavelength λi of the polymerization initiating agent was 381.5 nm, the set absorption wavelength λb of the polymerizable compound was 295 nm, and the set absorption wavelength λc of the polymerization initiating agent was 360 nm. In addition, the Ohnishi parameter of the resist composition was 2.765, and the ring parameter of the resist composition was 0.57.

The contents of the above formulations are summarized in Table 2.

TABLE 2

| | | | | | | | | | Parameter Values of Formulation | | | | | |
|---|---|---|---|---|---|---|---|---|---|---|---|---|---|---|
| | Contents of Formulation | | | | | | | | | λi of | | λc of | | |
| | | | | | Polymerization | | | | | Polymerization | | Polymerization | | |
| | | | | | Initiating | | | | λm of | Initiating | λb of | Initiating | | |
| | Monomer | | | | Agent | | Additive | | Monomer | Agent | Monomer | Agent | Ohnishi | Ring |
| Formulation | Type | Ratio | Type | Ratio | Type | Ratio | Type | Ratio | nm | nm | nm | nm | P | P |
| 1-1 | A | 100 | — | — | Irg379 | 2 | PF3320 | 2 | 252 | 381.5 | 276 | 360 | 3.2 | 0.43 |
| 1-2 | B | 80 | M220 | 20 | Irg379 | 2 | PF3320 | 2 | 305 | 381.5 | 295 | 360 | 2.864 | 0.568 |
| 1-3 | C | 80 | M220 | 20 | Irg379 | 2 | PF3320 | 2 | 282.5 | 381.5 | 285 | 360 | 3.048 | 0.44 |
| 1-4 | D | 80 | M220 | 20 | Irg379 | 2 | PF3320 | 2 | 314 | 381.5 | 300 | 360 | 2.864 | 0.568 |
| 1-5 | E | 80 | M220 | 20 | Irg379 | 2 | PF3320 | 2 | 319.5 | 381.5 | 310 | 360 | 2.816 | 0.616 |
| 1-6 | A | 50 | B | 50 | Irg379 | 2 | PF3320 | 2 | 305 | 381.5 | 295 | 360 | 2.765 | 0.57 |

### <Imprinting Step>

Nanoimprinting operations were executed using each of the resist compositions prepared in the formulating step described above.

First, an ink jet printer (DMP2831 by Dimatix) was utilized and controlled such that the viscosities of the resist compositions were 10cP when expelled. A droplet arrangement pattern was selected such that solid films having film thicknesses of 60 nm were formed on Si substrates by the ink jet method. Note that Si substrates that underwent a silane coupling agent process were employed as the substrates. Specifically, a surface processing apparatus (MVD150 by AMST) was employed to form uniform films of acryloyloxypropyl trimethoxysilane (KBM5103 by Shinetsu Chemical Industries) on the Si substrates by the MVD (Molecular Vapor Deposition) method. The contact angles of water on the surfaces of the processed Si substrates were 71.3 degrees.

Next, quartz molds and the Si substrates having the resist compositions coated thereon were placed in contact within a He atmosphere. Then, the assemblies constituted by the quartz molds and the Si substrates were placed in pressure vessels, and pressure was applied across under conditions of 2 atmospheric pressures for 1 minute. In the pressurized state, a predetermined exposure system was utilized to perform exposure. Then, the interiors of the pressure vessels were depressurized, the assemblies were removed therefrom, and the molds were separated from the resist compositions.

The exposure system utilized three types of lamps and two optical filters to constitute exposure systems of six formats. The detailed combinations of the lamps and optical filters are indicated in Table 3 below. Note that with respect to the types of lamps indicated in Table 3, “HP Hg” refers to a high pressure mercury lamp by Sen Lights, “Metal Halide” refers to a metal halide lamp SMX-3000 by ORC Manufacturing, and “UV-LED” refers to an LED light source L11403-1104 by Hamamatsu Photonics. In addition, with respect to the filters, “U36” means that UVTAF-36 by Sigma Optics was utilized, and “310BP” means that a band pass filter MZ0310 by Asahi Spectral was utilized.

### <Evaluation Method>

Judgments regarding whether favorable imprinting operations were executed were rendered by measuring the amounts of the resist compositions which were adhered to the surfaces of the molds after 20 imprinting operations (cycles including coating of the resist compositions on the substrates, placing the molds in contact with the substrates, curing the resist compositions, and separating the molds) were executed. Surface analysis was executed by XPS (X ray Photon Spectroscopy) related to the adhered amounts, and relative values of the peaks derived from the resist compositions with respect to the peak derived from Si (C—C and C—O peaks) were calculated from the measured data. Cases in which the relative values were 0 were judged as cases in which particularly favorable imprinting operations were executed, and evaluated as VG (Very Good). Cases in which the relative values were greater than 0 and 0.5 or less were judged as cases in which favorable imprinting operations were executed, and evaluated as GOOD. Cases in which the relative values were greater than 0.5 were judged as cases in which favorable imprinting operations were not executed, and evaluated as POOR.

### <Evaluation Results>

Table 3 also indicates evaluation results obtained by the evaluation method obtained above.

The results indicated that contamination of molds due to adherence and accumulation of components derived from the resist (decomposed matter) onto the molds occurred in systems in which the intensity spectrum properties of the exposure system and the absorption spectrum properties of polymerizable compounds overlapped. In contrast, in the systems of the present invention, in which the intensity spectrum properties and the absorption spectrum properties were completely separated, contamination of molds did not occur, and it was seen that the problem of deteriorating durability due to contamination of molds was less likely to occur.

TABLE 3

| | | | | | | | | | | LAMP | |
|---|---|---|---|---|---|---|---|---|---|---|---|
| | | | λc of | HP Hg | | Metal Halide | | | UV LED | FILTER | |
| | | λb of | Polymerization | No | | No | | | No | λa of | |
| | | Monomer | Initiating Agent | Filter | U36 | Filter | U36 | 310BP | Filter | Exposure | Light |
| | | nm | nm | 253 | 313 | 250 | 310 | 303 | 353 | System | Source |
| Formulation | 1-1 | 276 | 360 | POOR | VG | POOR | VG | VG | VG | | |
| | 1-2 | 295 | 360 | POOR | GOOD | POOR | GOOD | GOOD | VG | | |
| | 1-3 | 285 | 360 | POOR | VG | POOR | VG | VG | VG | | |
| | 1-4 | 300 | 360 | POOR | GOOD | POOR | GOOD | GOOD | VG | | |
| | 1-5 | 310 | 360 | POOR | GOOD | POOR | GOOD | POOR | VG | | |
| | 1-6 | 295 | 360 | POOR | GOOD | POOR | GOOD | GOOD | VG | | |

### <Investigations Regarding Appropriate Combinations of Polymerizable Compounds and Exposure Systems>

Next, appropriate combinations of polymerizable compounds and polymerization exposure systems will be considered.

### <Resist Composition Formulating Step>

6 resist compositions were prepared according to the 6 formulations below. Note that Monomer A, Monomer B, M220 and M310 in the steps described below are compounds having the structures indicated in Table 1 above.

### (Formulation 2-1)

Monomer A and Monomer B of Table 1 were employed as polymerizable compounds, Darocure™ 1173 (by BASF Japan) was employed as a polymerization initiating agent, and PF3320 (by OMNOVA) was employed as an additive. Monomer A, Monomer B, Darocure™ 1173 and PF3320 were mixed at a ratio of 50:50:2:2, to prepare a resist composition.

The absorption spectrum properties of the resist composition prepared according to formulation 2-1 were measured. As a result, the longer wavelength end wavelength λm of the polymerizable compound (Monomer B; the same applies to Formulations 2-2 and 2-3) was 305 nm, the longer wavelength end wavelength λi of the polymerization initiating agent was 305 nm, the set absorption wavelength λb of the polymerizable compound was 295 nm, and the set absorption wavelength λc of the polymerization initiating agent was 280 nm. In addition, the Ohnishi parameter of the resist composition was 2.765, and the ring parameter of the resist composition was 0.57.

### (Formulation 2-2)

Monomer A and Monomer B of Table 1 were employed as polymerizable compounds, Irgacure™ 379 was employed as a polymerization initiating agent, and PF3320 was employed as an additive. Monomer A, Monomer B, Irgacure™ 379, and PF3320 were mixed at a ratio of 50:50:2:2, to prepare a resist composition.

The absorption spectrum properties of the resist composition prepared according to formulation 2-2 were measured. As a result, the longer wavelength end wavelength λm of the polymerizable compound was 305 nm, the longer wavelength end wavelength λi of the polymerization initiating agent was 381.5 nm, the set absorption wavelength λb of the polymerizable compound was 295 nm, and the set absorption wavelength λc of the polymerization initiating agent was 360 nm. In addition, the Ohnishi parameter of the resist composition was 2.765, and the ring parameter of the resist composition was 0.57.

### (Formulation 2-3)

Monomer A and Monomer B of Table 1 were employed as polymerizable compounds, Irgacure™ 784 was employed as a polymerization initiating agent, and PF3320 was employed as an additive. Monomer A, Monomer B, Irgacure™ 784, and PF3320 were mixed at a ratio of 50:50:2:2, to prepare a resist composition.

The absorption spectrum properties of the resist composition prepared according to formulation 2-3 were measured. As a result, the longer wavelength end wavelength λm of the polymerizable compound was 305 nm, the longer wavelength end wavelength λi of the polymerization initiating agent was 550 nm, the set absorption wavelength λb of the polymerizable compound was 295 nm, and the set absorption wavelength λc of the polymerization initiating agent was 520 nm. In addition, the Ohnishi parameter of the resist composition was 2.765, and the ring parameter of the resist composition was 0.57.

### (Formulation 2-4)

M220 and M310 of Table 1 were employed as polymerizable compounds, Darocure™ 1173 was employed as a polymerization initiating agent, and PF3320 was employed as an additive. M220, M310, Darocure™ 1173, and PF3320 were mixed at a ratio of 70:30:2:2, to prepare a resist composition.

The absorption spectrum properties of the resist composition prepared according to formulation 2-4 were measured. As a result, the longer wavelength end wavelength λm of the polymerizable compound (M220; the same applies to Formulations 2-5 and 2-6) was less than 250 nm, the longer wavelength end wavelength λi of the polymerization initiating agent was 305 nm, the set absorption wavelength λb of the polymerizable compound was less than 250 nm, and the set absorption wavelength λc of the polymerization initiating agent was 280 nm. In addition, the Ohnishi parameter of the resist composition was 4.39, and the ring parameter of the resist composition was 0.

### (Formulation 2-5)

M220 and M310 of Table 1 were employed as polymerizable compounds, Irgacure™ 379 was employed as a polymerization initiating agent, and PF3320 was employed as an additive. M220, M310, Irgacure™ 379, and PF3320 were mixed at a ratio of 70:30:2:2, to prepare a resist composition.

The absorption spectrum properties of the resist composition prepared according to formulation 2-5 were measured. As a result, the longer wavelength end wavelength λm of the polymerizable compound was less than 250 nm, the longer wavelength end wavelength λi of the polymerization initiating agent was 381.5 nm, the set absorption wavelength λb of the polymerizable compound was less than 250 nm, and the set absorption wavelength λc of the polymerization initiating agent was 360 nm. In addition, the Ohnishi parameter of the resist composition was 4.39, and the ring parameter of the resist composition was 0.

### (Formulation 2-6)

M220 and M310 of Table 1 were employed as polymerizable compounds, Irgacure™ 784 was employed as a polymerization initiating agent, and PF3320 was employed as an additive. M220, M310, Irgacure™ 784, and PF3320 were mixed at a ratio of 70:30:2:2, to prepare a resist composition.

The absorption spectrum properties of the resist composition prepared according to formulation 2-6 were measured. As a result, the longer wavelength end wavelength λm of the polymerizable compound was less than 250 nm, the longer wavelength end wavelength λi of the polymerization initiating agent was 550 nm, the set absorption wavelength λb of the polymerizable compound was less than 250 nm, and the set absorption wavelength λc of the polymerization initiating agent was 520 nm. In addition, the Ohnishi parameter of the resist composition was 4.39, and the ring parameter of the resist composition was 0.

The contents of the above formulations are summarized in Table

TABLE 4

| | | | | | | | | | Parameter Values of Formulation | | | | | |
|---|---|---|---|---|---|---|---|---|---|---|---|---|---|---|
| | | | | | | | | | | λi of | | λc of | | |
| | Contents of Formulation | | | | | | | | | Polymer- | | Polymer- | | |
| | | | | | Polymerization | | | | | ization | | ization | | |
| | | | | | Initiating | | | | λm of | Initiating | λb of | Initiating | | |
| | Monomer | | | | Agent | | Additive | | Monomer | Agent | Monomer | Agent | Ohnishi | Ring |
| Formulation | Type | Ratio | Type | Ratio | Type | Ratio | Type | Ratio | nm | nm | nm | nm | P | P |
| 2-1 | A | 50 | B | 50 | Darl173 | 2 | PF3320 | 2 | 305 | 305 | 295 | 280 | 2.765 | 0.57 |
| 2-2 | A | 50 | B | 50 | Irg379 | 2 | PF3320 | 2 | 305 | 381.5 | 295 | 360 | 2.765 | 0.57 |
| 2-3 | A | 50 | B | 50 | Irg784 | 2 | PF3320 | 2 | 305 | 550 | 295 | 520 | 2.765 | 0.57 |
| 2-4 | M22C | 70 | M310 | 30 | Darl173 | 2 | PF3320 | 2 | <250 | 305 | <250 | 280 | 4.39 | 0 |
| 2-5 | M22C | 70 | M310 | 30 | Irg379 | 2 | PF3320 | 2 | <250 | 381.5 | <250 | 360 | 4.39 | 0 |
| 2-6 | M22C | 70 | M310 | 30 | Irg784 | 2 | PF3320 | 2 | <250 | 550 | <250 | 520 | 4.39 | 0 |

### <Imprinting Step>

Nanoimprinting operations were executed using each of the resist compositions prepared in the formulating step described above.

First, an ink jet printer (DMP2831 by Dimatix) was utilized and controlled such that the viscosities of the resist compositions were 10 cP when expelled. A droplet arrangement pattern was selected such that solid films having film thicknesses of 60 nm were formed on Si substrates by the ink jet method. Note that Si substrates that underwent a silane coupling agent process were employed as the substrates. Specifically, a surface processing apparatus (MVD150 by AMST) was employed to form uniform films of acryloyloxypropyl trimethoxysilane (KBM5103 by Shinetsu Chemical Industries) on the Si substrates by the MVD (Molecular Vapor Deposition) method. The contact angles of water on the surfaces of the processed Si substrates were 71.3 degrees.

Next, quartz molds and the Si substrates having the resist compositions coated thereon were placed in contact within a He atmosphere. Then, the assemblies constituted by the quartz molds and the Si substrates were placed in pressure vessels, and pressure was applied across under conditions of 2 atmospheric pressures for 1 minute. In the pressurized state, a predetermined exposure system was utilized to perform exposure. Then, the interiors of the pressure vessels were depressurized, the assemblies were removed therefrom, and the molds were separated from the resist compositions.

The exposure system utilized three types of lamps and two optical filters to constitute exposure systems of four formats. The four formats are indicated in Table 5 below. Note that with respect to the types of lamps indicated in Table 5, “MH (NF)” refers to a metal halide lamp SMX-3000 by ORC Manufacturing, “310 nm” refers to a combination of the SMX-3000 light source and a band pass filter MZ0310 (which transmits light within a wavelength region of 310 nm±10 nm) by Asahi Spectral, “UV-LED” refers to an LED light source L11403-1104 by Hamamatsu Photonics, and “UV Cut” refers to a combination of the SMX-3000 light source and a sharp cut filter SCF-37L (which shields light having wavelengths of 370 nm or less) by Sigma Optics.

Note the exposure amounts were adjusted by performing exposure with an irradiation dosage measurement wavelength such that the total amount of energy was 1500 mJ/cm² in all cases.

### <Evaluation Method>

Judgments regarding whether favorable imprinting operations were executed were based on the degrees to which contamination of molds due to adhered matter was suppressed, etching resistance during dry etching, and the pattern forming properties of patterns of protrusions and recesses transferred to the Si substrates following dry etching (RIE: Reactive Ion Etching).

The degrees to which contamination of the molds due to adhered matter were evaluated by measuring the amounts of the resist compositions which were adhered to the surfaces of the molds after 20 imprinting operations (cycles including coating of the resist compositions on the substrates, placing the molds in contact with the substrates, curing the resist compositions, and separating the molds) were executed. Surface analysis was executed by XPS (X ray Photon Spectroscopy) related to the adhered amounts, and relative values of the peaks derived from the resist compositions with respect to the peak derived from Si (C—C and C—O peaks) were calculated from the measured data. Cases in which the relative values were 0 were judged as cases in which particularly favorable imprinting operations were executed, and evaluated as VG (Very Good). Cases in which the relative values were greater than 0 and 0.5 or less were judged as cases in which favorable imprinting operations were executed, and evaluated as GOOD. Cases in which the relative values were greater than 0.5 were judged as cases in which favorable imprinting operations were not executed, and evaluated as POOR.

The etching resistance during dry etching was evaluated by calculating etching rates for RIE, then basing evaluations on selectivity with respect to Si. Cases in which the selectivity was 2 or greater were judged as cases in which favorable imprinting operations were executed, and evaluated as GOOD. Cases in which the selectivity was less than 2 were judged as cases in which favorable imprinting operations were not executed, and evaluated as POOR.

Note that the aforementioned selectivity was obtained by calculating (Etching Rate of Si)/(Etching Rate of Resist). RIE was executed using an etching apparatus (ICP etching apparatus NE-550 by ULVAC), and etching rates of CHF₃/Ar gas series etching were evaluated.

The pattern forming properties of patterns of protrusions and recesses transferred to the Si substrates following dry etching were evaluated by processing the Si substrates by RIE using a resist pattern produced by a 100th imprinting operation as a mask, observing the surface of the processed substrate with an SEM, then judging whether shapes corresponding to the patterns of the molds were obtained. Cases in which dimensional shifts of the patterns of protrusions and recesses on the Si substrates were within a range of 20% or less and there were no pattern defects were judged as cases in which particularly favorable imprinting were executed, and evaluated as VG (Very Good). Cases in which dimensional shifts of the patterns of protrusions and recesses on the Si substrates were within a range of 20% or less and pattern defects were present at a percentage of 10% or less were judged as cases in which favorable imprinting were executed, and evaluated as GOOD. Cases in which dimensional shifts of the patterns of protrusions and recesses on the Si substrates were within a range of greater than 20% or pattern defects were present at a percentage of greater than 10% were judged as cases in which favorable imprinting were not executed, and evaluated as POOR.

### <Evaluation Results>

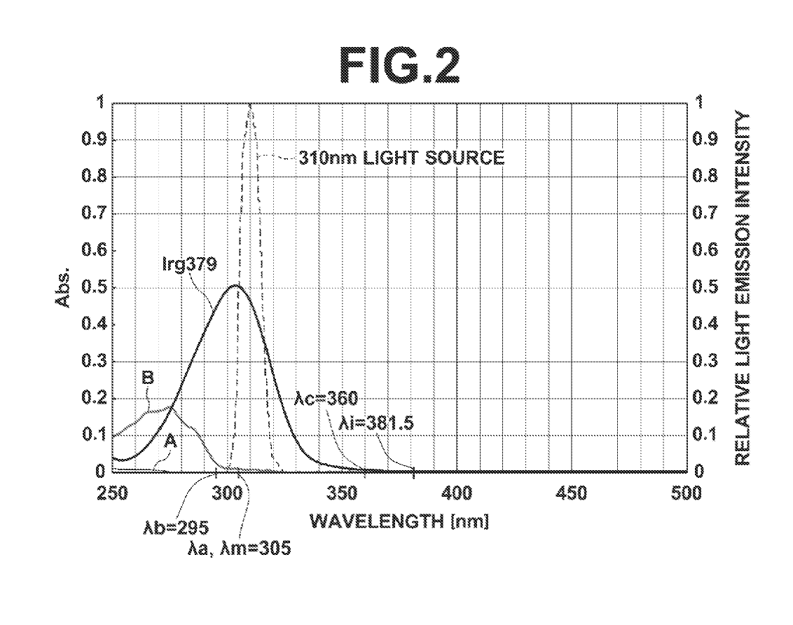

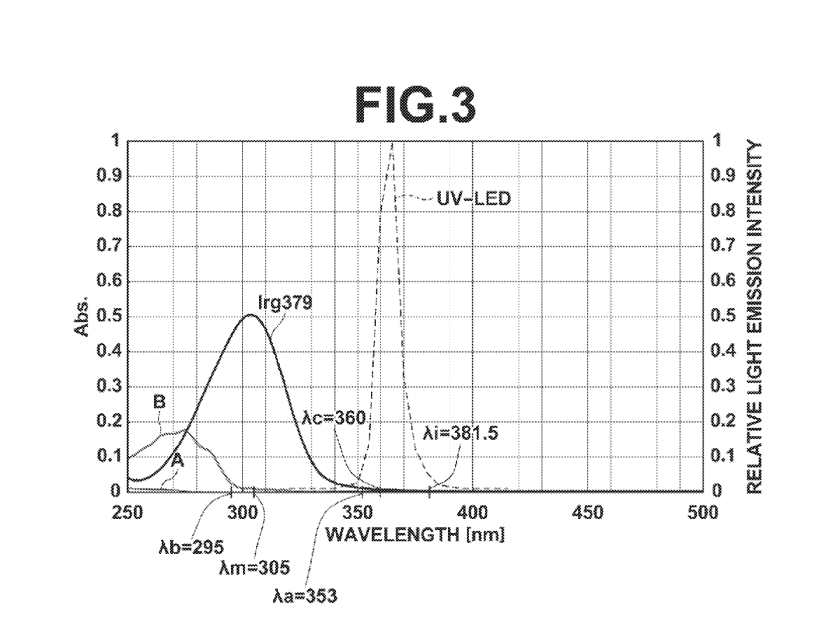

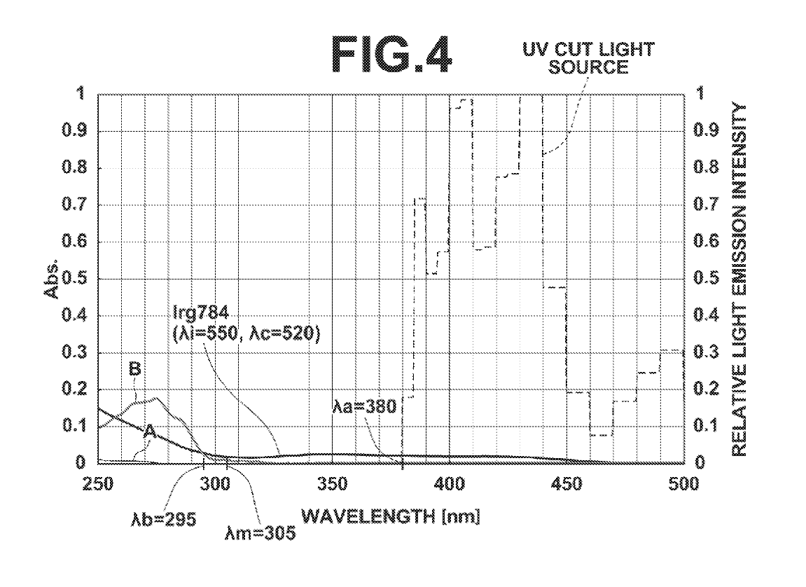

Table 5 also indicates evaluation results obtained by the evaluation method obtained above. In addition, FIG. 1 is a graph that illustrates the absorption spectrum properties of a polymerizable compound and a polymerization initiating agent and the intensity spectrum properties of an exposure system of Comparative Example 1 indicated in Table 5. FIG. 2 is a graph that illustrates the absorption spectrum properties of a polymerizable compound and a polymerization initiating agent and the intensity spectrum properties of an exposure system of Example 1 indicated in Table 5. FIG. 3 is a graph that illustrates the absorption spectrum properties of a polymerizable compound and a polymerization initiating agent and the intensity spectrum properties of an exposure system of Example 2 indicated in Table 5. FIG. 4 is a graph that illustrates the absorption spectrum properties of a polymerizable compound and a polymerization initiating agent and the intensity spectrum properties of an exposure system of Example 3 indicated in Table 5.

The results indicated that contamination of molds due to adherence and accumulation of components derived from the resist (decomposed matter) onto the molds occurred in cases that the intensity spectrum properties of the exposure system and the absorption spectrum properties of polymerizable compounds overlapped. In contrast, in cases in which the intensity spectrum properties and the absorption spectrum properties were completely separated, contamination of molds did not occur, and it was seen that the problem of deteriorating durability due to contamination of molds was less likely to occur. In addition, shortening of exposure time was possible in cases that the intensity spectrum properties and the absorption spectrum properties did not overlap, and it was recognized that productivity could be further improved.

Further, in the present invention, it was recognized that contamination of molds was suppressed, etching resistance was secured, and processing precision of substrates was also favorable in cases that the set light emitting wavelength was 340 nm or greater.

TABLE 5

| | | | λc of | Photocuring Conditions | | | | | | |
|---|---|---|---|---|---|---|---|---|---|---|
| | | | Polymerization | | λa of | Dosage | | | | |
| | | λb of | Initiating | | Exposure | Measurement | | Evaluation Results | | |
| | | Monomer | Agent | Exposure | System | Wavelength | Dosage | Contamination | Etching | Pattern |
| | Formulation | nm | nm | System | nm | nm | mJ/cm2 | of Mold | Resistance | Formability |
| Comparative | 2-1 | 295 | 280 | MH (NF) | 250 | 365 | 1500 | POOR | VG | POOR |
| Example 1 | | | | | | | | | | |
| Example 1 | 2-2 | 295 | 360 | 310 nm | 305 | 310 | 1500 | GOOD | VG | POOR |
| Example 2 | 2-2 | 295 | 360 | UV-LED | 353 | 365 | 1500 | VG | VG | VG |
| Example 3 | 2-3 | 295 | 520 | UV Cut | 380 | 365 | 1500 | VG | VG | VG |
| Comparative | 2-4 | <250 | 280 | MH (NF) | 250 | 365 | 1500 | GOOD | POOR | POOR |
| Example 2 | | | | | | | | | | |
| Comparative | 2-5 | <250 | 360 | 310 nm | 305 | 310 | 1500 | VG | POOR | POOR |
| Example 3 | | | | | | | | | | |
| Comparative | 2-5 | <250 | 360 | UV-LED | 353 | 365 | 1500 | VG | POOR | POOR |
| Example 4 | | | | | | | | | | |
| Comparative | 2-6 | <250 | 520 | UV Cut | 380 | 365 | 1500 | VG | POOR | POOR |
| Example 5 | | | | | | | | | | |

What is claimed is:

1. A nanoimprinting method, comprising the steps of:
employing a mold having a fine pattern of protrusions and recesses on a surface thereof;
exposing a resist composition coated on a substrate to be processed while the resist composition is pressed with the pattern of protrusions and recesses, to cure the resist composition; and
separating the mold from the resist composition; wherein:
the resist composition includes polymerizable compounds and a polymerization initiating agent, each having absorption spectrum properties with absorption regions within a range from 250 nm to 500 nm;
the polymerization initiating agent having an absorption region with a longer wavelength end wavelength longer than the longer wavelength end wavelength of the absorption region of the polymerizable compounds; and
exposure of the resist composition being executed by light having spectral intensity properties that satisfy Formula 1 below:
λb<λa≦λc (1)
wherein λa is a set light emission wavelength related to spectral intensity properties within light within a wavelength range from 250 nm to 500 nm irradiated during the exposure, and represents a set light emission wavelength toward the shorter wavelength end at which the light emission intensity is 10% with respect to the light emission intensity at a maximum peak wavelength;
λb is a set absorption wavelength related to the absorption spectrum properties of the polymerizable compounds, and represents a set absorption wavelength at the longer wavelength end at which light absorption is 10% with respect to light absorption at a maximum peak wavelength; and
λc is a set absorption wavelength related to the absorption spectrum properties of the polymerization initiating agent, and represents a set absorption wavelength at the longer wavelength end at which light absorption is 10% with respect to light absorption at a maximum peak wavelength.

2. A nanoimprinting method as defined in claim 1, wherein:
the weighted average of the Ohnishi parameters related to all of the polymerizable compounds included in the resist composition is 3.5 or less; and
the weighted average of the ring parameters related to all of the polymerizable compounds is 0.3 or greater.

3. A nanoimprinting method as defined in claim 1, wherein:
the Ohnishi parameter related to at least one of the polymerizable compounds included in the resist composition is 3.5 or less, the ring parameter of the at least one polymerizable compound is 0.3 or greater, and the at least one polymerizable compound has an aromatic group.

4. A nanoimprinting method as defined in claim 2, wherein:
the Ohnishi parameter related to at least one of the polymerizable compounds included in the resist composition is 3.5 or less, the ring parameter of the at least one polymerizable compound is 0.3 or greater, and the at least one polymerizable compound has an aromatic group.

5. A nanoimprinting method as defined in claim 1, wherein:
the polymerizable compounds include at least one compound selected from compounds represented by General Formula I and General Formula II below: 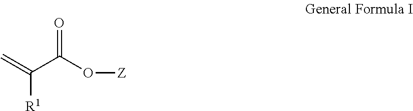
wherein Z represents a group that includes an aromatic group, and R¹ represents a hydrogen atom, an alkyl group, or a halogen atom 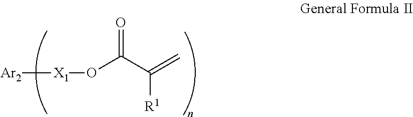
wherein Ar₂ represents a linking group having an aromatic group and a valence of n (n is an integer from 1 to 3), X₂ represents a single bond or a hydrocarbon group, and R¹ represents a hydrogen atom, an alkyl group, or a halogen atom.

6. A nanoimprinting method as defined in claim 1, wherein:
the maximum peak wavelength of the absorption spectrum properties of the polymerization initiating agent is 340 nm or greater.

7. A nanoimprinting method as defined in claim 1, wherein:
the set light emission wavelength is 340 nm or greater.

8. A nanoimprinting method as defined in claim 1, wherein:
an exposure system for executing exposure is equipped with an LED light source; and
the maximum peak wavelength in the spectral intensity properties of the light is 350 nm or greater.

9. A nanoimprinting method as defined in claim 8, wherein:
the exposure system is equipped with a sharp cut filter having a transmissivity of 1% or less, at least with respect to light having a wavelength of 300 nm.

10. A nanoimprinting method as defined in claim 8, wherein:
the exposure system is equipped with a sharp cut filter having a transmissivity of 1% or less, at least with respect to light having a wavelength of 340 nm.

11. A resist composition to be utilized in the nanoimprinting method defined in claim 1, wherein:
the resist composition includes polymerizable compounds and a polymerization initiating agent, each having absorption spectrum properties with absorption regions within a range from 250 nm to 500 nm; and
the polymerization initiating agent has an absorption region with a longer wavelength end wavelength longer than the longer wavelength end wavelength of the absorption region of the polymerizable compounds.

12. A resist composition as defined in claim 11, wherein:
the weighted average of the Ohnishi parameters related to all of the polymerizable compounds included in the resist composition is 3.5 or less; and
the weighted average of the ring parameters related to all of the polymerizable compounds is 0.3 or greater.

13. A resist composition as defined in claim 11, wherein:
the Ohnishi parameter related to at least one of the polymerizable compounds included in the resist composition is 3.5 or less, the ring parameter of the at least one polymerizable compound is 0.3 or greater, and the at least one polymerizable compound has an aromatic group.

14. A resist composition as defined in claim 12, wherein:
the Ohnishi parameter related to at least one of the polymerizable compounds included in the resist composition is 3.5 or less, the ring parameter of the at least one polymerizable compound is 0.3 or greater, and the at least one polymerizable compound has an aromatic group.

15. A resist composition as defined in claim 11, wherein:
the polymerizable compounds includes at least one compound selected from compounds represented by General Formula I and General Formula II below: 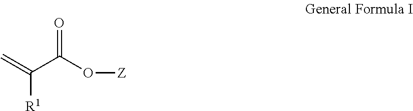
wherein Z represents a group that includes an aromatic group, and R¹ represents a hydrogen atom, an alkyl group, or a halogen atom 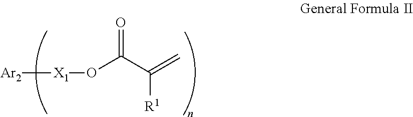
wherein Ar₂ represents a linking group having an aromatic group and a valence of n (n is an integer from 1 to 3), X₂ represents a single bond or a hydrocarbon group, and R¹ represents a hydrogen atom, an alkyl group, or a halogen atom.

16. A resist composition as defined in claim 11, wherein:
the maximum peak wavelength of the absorption spectrum properties of the polymerization initiating agent is 340 nm or greater.
